(19) United States
(12) Patent Application Publication
(10) Pub. No.: US 2026/0205424 A1
(43) Pub. Date: Jul. 16, 2026

(54) ETHERNET PACKET PROCESSING DEVICE WITH MINIMAL DELAY

(71) Applicant: Navitron LLC, Glendale, AZ (US)

(72) Inventors: Salar Navidi, Glendale, AZ (US); Thomas Alan Pruitt, Glendale, AZ (US)

(21) Appl. No.: 19/446,330

(22) Filed: Jan. 12, 2026

Related U.S. Application Data
(60) Provisional application No. 63/743,655, filed on Jan. 10, 2025.

(51) Int. Cl. H04L 49/351; H04L 5/14

(52) U.S. Cl. CPC H04L 49/351; H04L 5/14

(57) ABSTRACT

A device for processing Ethernet packets may include first and second full duplex ports configured to receive and transmit packets. A media independent interface (MII) may be coupled to both ports. First and second configuration tables may store packet match criteria and corresponding manipulations. Packets received at the first port may be processed according to the first table and transmitted from the second port, and vice versa. An FPGA may be coupled to the MII and configuration tables and may inspect MAC destination address bits, compare them against match criteria, perform manipulations on matched packets, and forward manipulated or unmatched packets with delay under 6 microseconds at 100 megabits per second.

### CROSS-REFERENCE TO RELATED APPLICATIONS

This application claims priority to U.S. Provisional Application 63/743,655, titled “Ethernet Packet Processing Device with Minimal Delay,” filed Jan. 10, 2025, which is hereby incorporated by reference in its entirety.

### FIELD OF INVENTION

The present disclosure relates to Ethernet packet processing devices.

### BACKGROUND

Ethernet networks have become prevalent in modern computing environments, serving as the backbone for local area networks in homes, offices, industrial, automotive, and aviation settings. As Ethernet technology has evolved, data transmission speeds have increased from the original 10 Mbps to current standards supporting 100 Gbps and beyond, creating challenges for network diagnostic and testing tools that attempt to analyze network performance, identify issues, and ensure reliability of data transmission. Traditional network analysis tools often operate at higher layers of the OSI model, which can introduce latency and may not provide the granular, real-time insights desired for modern high-speed networks. Existing network diagnostic tools that operate at the application layer often face challenges in providing real-time packet inspection, manipulation, and forwarding capabilities without introducing delays that can be problematic in time-sensitive applications or when testing network performance under various conditions. Furthermore, as Ethernet networks are deployed in an increasingly diverse range of environments, including automotive and industrial applications, the challenges for flexible and adaptable diagnostic tools have become more pronounced, as these tools may need to handle various Ethernet standards and protocols while providing detailed insights into network behavior under both normal and abnormal conditions. The ability to simulate network anomalies, such as packet loss or corruption, in a controlled manner is also desirable for thorough network testing and validation, yet many existing tools lack the capability to perform such operations with the precision and flexibility that may be desired for comprehensive network analysis.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In some examples, a device for processing an Ethernet packet is provided. The device includes a first full duplex port and a second full duplex port, each port configured to receive and transmit Ethernet packets. The device includes a media independent interface (MII) coupled to the first full duplex port and the second full duplex port. The device includes a first configuration table and a second configuration table, each configuration table storing one or more packet match criteria and one or more corresponding packet manipulations. An Ethernet packet comprises a media access control (MAC) destination address comprising bits that uniquely identifies an intended recipient within a network. An Ethernet packet received at the first full duplex port is processed according to the first configuration table and transmitted out of the second full duplex port. An Ethernet packet received at the second full duplex port is processed according to the second configuration table and transmitted out of the first full duplex port. The device includes a field-programmable gate array (FPGA) coupled to the MII, the first configuration table, and the second configuration table. The FPGA is configured to inspect a subset of bits of a MAC destination address of an Ethernet packet at the MII, the subset of bits comprising 12 bits first listed in the bits. The FPGA is configured to compare the subset of bits that was inspected against the one or more packet match criteria in the first configuration table or the second configuration table to determine whether an Ethernet packet is a matched packet when a match is found or an unmatched packet when no match is found. The FPGA is configured to perform a packet manipulation on a matched packet according to the one or more corresponding packet manipulations in the first configuration table or the second configuration table to produce a manipulated packet. The FPGA is configured to forward a manipulated packet or an unmatched packet to the first full duplex port or the second full duplex port with minimal delay of less than 6 microseconds in a network operating at a network speed of 100 megabits per second (e.g. 100Base-T) and less than 1 microsecond in a network operating at network speed of 1 gigabit per second (e.g. 1000Base-T).

In some examples, the device may include one or more of the following features. The packet manipulation may comprise at least one of: packet content modification with cyclic redundancy check (CRC) update, packet termination, CRC corruption, or introducing a specified packet delay. The device may further include a third full duplex port and a fourth full duplex port, each port configured to receive and transmit an Ethernet packet. The device may include a third configuration table and a fourth configuration table, each configuration table storing one or more packet match criteria and one or more corresponding packet manipulations. An Ethernet packet received at the third full duplex port may be processed according to the third configuration table and transmitted out of the fourth full duplex port. An Ethernet packet received at the fourth full duplex port may be processed according to the fourth configuration table and transmitted out of the third full duplex port. The FPGA may be coupled to the third configuration table and the fourth configuration table. The FPGA may be configured to inspect a subset of bits of a MAC destination address of an Ethernet packet at the MII, the subset of bits comprising 12 bits first listed in the bits. The FPGA may be configured to compare the subset of bits that was inspected against the one or more packet match criteria in the third configuration table or the fourth configuration table to determine whether an Ethernet packet is a matched packet when a match is found or an unmatched packet when no match is found. The FPGA may be configured to perform a packet manipulation on a matched packet received at the third full duplex port or the fourth full duplex port according to the one or more corresponding packet manipulations in the third configuration table or the fourth configuration table. The FPGA may be configured to forward a manipulated or an unmatched packet to the third full duplex port or the fourth full duplex port with minimal delay of less than 6 microseconds in a network operating at a network speed of 100 megabits per second and less than 1 microsecond in a network operating at network speed of 1 gigabit per second. The FPGA may be further configured to operate in a sequential mode or a concurrent mode based on at least one of the first configuration table and the second configuration table. In the sequential mode, the FPGA may increment to a next entry in at least one of the first configuration table and the second configuration table after performing a packet manipulation. In the concurrent mode, the FPGA may directly index into at least one of the first configuration table and the second configuration table based on the one or more packet match criteria. The device may further include a third full duplex port and a fourth full duplex port, each port configured to receive and transmit a plurality of Ethernet packets, and a timestamp system configured to add a timestamp to a payload of one or more selected Ethernet packets of a plurality of Ethernet packets received at or transmitted out of the third full duplex port or the fourth full duplex port. The device may further include one or more timers and a timestamp system, wherein either the one or more timers or the timestamp system synchronizes time to an Ethernet packet. The device may further include a plurality of Ethernet packets and a plurality of independent timers, wherein the FPGA is configured to activate one or more of the plurality of independent timers to measure timing between each of the plurality of Ethernet packets based on at least one of the first configuration table and the second configuration table.

In some examples, a method for processing an Ethernet packet is provided. The method includes receiving an Ethernet packet at a first full duplex port of a diagnostic device. The method includes inspecting, at a media independent interface (MII) layer, a subset of bits of a MAC destination address of the Ethernet packet, the subset of bits comprising 12 bits first listed in the subset of bits. The method includes comparing the subset of bits that was inspected against one or more packet match criteria stored in at least one configuration table to determine whether the Ethernet packet is a matched packet when a match is found or an unmatched packet when no match is found. If the Ethernet packet is a matched packet, the method includes performing a packet manipulation on the matched packet to produce a manipulated packet, wherein the packet manipulation is specified in the at least one configuration table. The method includes forwarding the manipulated packet or an unmatched packet to a second full duplex port of the diagnostic device with a delay of less than 6 microseconds.

In some examples, the method may include one or more of the following features. The packet manipulation may include at least one of: packet content modification with CRC update, packet termination, CRC corruption, or introducing a specified packet delay. The method may further include receiving a plurality of Ethernet packets at the first full duplex port, and activating one or more independent timers to measure timing between each of the plurality of Ethernet packets received at the first full duplex port. The method may further include operating in a sequential mode or a concurrent mode based on the at least one configuration table. The sequential mode may comprise incrementing to a next entry in the at least one configuration table after performing a packet manipulation. The concurrent mode may comprise directly indexing into the at least one configuration table based on the one or more packet match criteria. The method may further include a plurality of Ethernet packets, a third full duplex port and a fourth full duplex port, each port configured to receive and transmit the plurality of Ethernet packets, and adding a timestamp to a payload of one or more selected Ethernet packets of the plurality of Ethernet packets received at or transmitted out of the third full duplex port or the fourth full duplex port. The method may further include receiving a plurality of Ethernet packets at the diagnostic device, the plurality of Ethernet packets comprising at least a first Ethernet packet and a second Ethernet packet, receiving the first Ethernet packet at the first full duplex port and transmitting the first Ethernet packet out of the second full duplex port, receiving the second Ethernet packet at a third full duplex port and transmitting the second Ethernet packet out of a fourth full duplex port, entirely copying content of the first Ethernet packet to produce an entirely copied first Ethernet packet or selectively copying content of the first Ethernet packet to produce a selectively copied first Ethernet packet, entirely copying content of the second Ethernet packet to produce an entirely copied second Ethernet packet or selectively copying content of the second Ethernet packet to produce a selectively copied second Ethernet packet, receiving the entirely copied first Ethernet packet or selectively copied first Ethernet packet at a third full duplex port and transmitting the entirely copied first Ethernet packet or selectively copied first Ethernet packet out of a fourth full duplex port, and receiving the entirely copied second Ethernet packet or selectively copied second Ethernet packet at the fourth full duplex port and transmitting the entirely copied second Ethernet packet or selectively copied second Ethernet packet out of the third full duplex port. The method may further include selectively dropping packets intermittently to simulate abnormal network conditions based on instructions in the at least one configuration table.

In some examples, a non-transitory computer-readable medium storing configuration data is provided. When used to configure a programmable logic device (PLD), the configuration data causes the PLD to perform operations for processing an Ethernet packet. The operations include receiving an Ethernet packet at a media independent interface layer (MII layer). The operations include inspecting a subset of bits of a MAC destination address of the Ethernet packet, the subset of bits comprising 12 bits first listed in the subset of bits. The operations include comparing the subset of bits that was inspected against one or more packet match criteria stored in at least one configuration table to determine whether the Ethernet packet is a matched packet if a match is found in the at least one configuration table or an unmatched packet if no match is found in the at least one configuration table. If the Ethernet packet is a matched packet, the operations include performing a packet manipulation on the matched packet to produce a manipulated packet, wherein the packet manipulation is specified in the at least one configuration table. The operations include forwarding the manipulated packet or an unmatched packet with a delay of less than 6 microseconds.

In some examples, the non-transitory computer-readable medium may include one or more of the following features. The packet manipulation may include at least one of: packet content modification with CRC update, packet termination, CRC corruption, or introducing a specified packet delay. The operations may further include receiving a plurality of Ethernet packets at the MII layer, and activating one or more independent timers to measure timing between each of the plurality of Ethernet packets based on instructions in the at least one configuration table. The operations may further include operating in a sequential mode or a concurrent mode based on the at least one configuration table. The sequential mode may comprise incrementing to a next entry in the at least one configuration table after performing a packet manipulation. The concurrent mode may comprise directly indexing into the at least one configuration table based on the one or more packet match criteria. The operations may further include adding a timestamp to a payload of an Ethernet packet. The operations may further include receiving a plurality of Ethernet packets at a diagnostic device, the plurality of Ethernet packets comprising at least a first Ethernet packet and a second Ethernet packet, receiving the first Ethernet packet at a first full duplex port and transmitting the first Ethernet packet out of a second full duplex port, receiving the second Ethernet packet at the second full duplex port and transmitting the second Ethernet packet out of the first full duplex port, entirely copying content of the first Ethernet packet to produce an entirely copied first Ethernet packet or selectively copying content of the first Ethernet packet to produce a selectively copied first Ethernet packet, entirely copying content of the second Ethernet packet to produce an entirely copied second Ethernet packet or selectively copying content of the second Ethernet packet to produce a selectively copied second Ethernet packet, receiving the entirely copied first Ethernet packet or selectively copied first Ethernet packet at a third full duplex port and transmitting the entirely copied first Ethernet packet or selectively copied first Ethernet packet out of a fourth full duplex port, and receiving the entirely copied second Ethernet packet or selectively copied second Ethernet packet at the fourth full duplex port and transmitting the entirely copied second Ethernet packet or selectively copied second Ethernet packet out of the third full duplex port.

The foregoing general description of the illustrative embodiments and the following detailed description thereof are merely exemplary aspects of the teachings of this disclosure and are not restrictive.

### BRIEF DESCRIPTION OF FIGURES

For purposes of promoting an understanding of the principles of the disclosure, reference will now be made to the embodiments illustrated in the drawings, and specific language will be used to describe the same. It will nonetheless be understood that no limitation of the scope of the disclosure is intended by the illustration and description of certain embodiments of the disclosure. In addition, any alterations and/or modifications of the illustrated and/or described embodiment(s) are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

FIG. 1 is a conceptual diagram of a block diagram of an example Ethernet network topology.

FIG. 2A is a conceptual diagram of a block diagram of an example Ethernet packet processing device.

FIG. 2B is a conceptual diagram of a block diagram of the example Ethernet packet processing device of FIG. 2A integrated into an Ethernet network.

FIG. 3 is a conceptual diagram of a block diagram of an example Ethernet packet processing device with a four-port configuration.

FIG. 4A is a conceptual diagram of a front panel view of an example Ethernet packet processing device.

FIG. 4B is a conceptual diagram of an isometric view of the example Ethernet packet processing device of FIG. 4A.

FIG. 5A is a conceptual diagram of a front view of an example Ethernet packet processing device.

FIG. 5B is a conceptual diagram of a top view of the example Ethernet packet processing device of FIG. 5A.

FIG. 6A is a conceptual diagram of an isometric view of an example Ethernet packet processing device.

FIG. 6B is a conceptual diagram of a rear view of the example Ethernet packet processing device of FIG. 6A.

FIG. 7 is a conceptual diagram of a flowchart of an example method for processing Ethernet packets.

FIG. 8 is a conceptual diagram of a sequence diagram of an example packet processing workflow.

FIG. 9 is a conceptual diagram of a sequence diagram of an example packet processing workflow with sequential and concurrent modes.

FIG. 10 is a conceptual diagram of a sequence diagram of an example packet processing workflow performed by an MII packet processor.

FIG. 11 is a conceptual diagram of a sequence diagram of an example packet processing flow in an MII packet processor device.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Traditional network diagnostic and testing tools that operate at higher layers of the Open Systems Interconnection (OSI) model face challenges in providing real-time packet inspection, manipulation, and forwarding capabilities without introducing delays. These delays can be problematic in time-sensitive applications or when testing network performance under various conditions. As Ethernet networks have evolved to support higher data transmission speeds and have been deployed in diverse environments including automotive, industrial, and aviation applications, the need for flexible and adaptable diagnostic tools has become more pronounced. Such tools may be capable of handling various Ethernet standards and protocols while providing detailed insights into network behavior under both normal and abnormal conditions. The ability to simulate network anomalies, such as packet loss or corruption, in a controlled manner may also be useful for thorough network testing and validation. However, many existing tools lack the capability to perform such operations with the precision and flexibility that may be desired for comprehensive network analysis.

The present disclosure includes a packet processing device that operates at a media independent interface (MII) level to enable real-time packet inspection, manipulation, forwarding, and sniffing with minimal delay for network diagnostics and robustness testing. In some cases, the packet processing device may execute full duplex operations at the MII level on Ethernet links and introduce delays of less than 7 microseconds at 100Base-T and less than 2 microseconds at 1000Base-T Ethernet protocols. The packet processing device may inspect a subset of bits of a packet's media access control (MAC) destination address to identify packets of interest, perform various operations on these packets, and forward manipulated or unmatched packets with minimal delay. Packets with no match may be routed to continue their original system routes. When a match is detected for a particular packet, operations may be performed according to a configuration table and the packet may be forwarded to continue its original system route.

In some cases, the present disclosure includes a processing device comprising one or more communication ports. Each communication port may be configured to receive and transmit Ethernet packets. The processing device may include a media independent interface coupled to the one or more communication ports. In some cases, the processing device may include one or more configuration tables, where each configuration table stores one or more packet match criteria and one or more corresponding packet manipulations. The packet match criteria may be based on various features of Ethernet packets, such as a subset of bits of a MAC destination address as defined as a Virtual Link (VL) identifier in the ARINC 664 Part 7 specification or other features in an Ethernet frame or packet format as defined by IEEE 802.3. Using the VL identifier may minimize transport delay within the packet processing device and may enable compatibility with existing higher level network traffic configuration and scheduling tools.

In some cases, the processing device may include a field-programmable gate array (FPGA) coupled to the media independent interface and the one or more configuration tables. An FPGA is an integrated circuit that can be configured by a customer or designer after manufacturing. FPGAs can be reprogrammed to perform a variety of functions. An FPGA may have a collection of configurable logic blocks (CLBs) that can implement complex combinational or sequential logic. Programmable interconnects may allow the CLBs to connect in various configurations. FPGAs may be capable of executing multiple processes in parallel, which may be advantageous for high-speed and low-latency tasks. Many FPGAs come with additional resources such as memory blocks, digital signal processing (DSP) slices, and sometimes embedded processors. An FPGA is a subset of Programmable Logic Devices (PLDs), which are a category of electronic components that can be programmed to implement various digital logic functions. In some cases, the FPGA may be configured to inspect a subset of bits of the MAC destination address of an Ethernet packet at the media independent interface, compare the inspected bits against the one or more packet match criteria in the one or more configuration tables to determine whether an Ethernet packet is a matched packet when a match is found or an unmatched packet when no match is found, perform a packet manipulation on a matched packet according to the one or more corresponding packet manipulations in the one or more configuration tables to produce a manipulated packet, and forward a manipulated packet or an unmatched packet with minimal delay.

As used herein, terms such as “first,” “second,” “third,” “fourth,” and similar ordinal terms are used for convenience to distinguish between different elements and are not intended to be limiting. These terms do not imply any particular order, sequence, or hierarchy unless the context clearly indicates otherwise. Similarly, directional terms such as “top,” “bottom,” “front,” “rear,” “left,” and “right” are used for convenience of description with reference to the drawings and are not intended to limit the scope of the present disclosure to any particular orientation or configuration.

Throughout the present disclosure, similar reference numerals may be used to identify corresponding or analogous components across different figures. When a reference numeral is used in multiple figures, the reference numeral identifies a component that may have similar structure, function, or both, unless the context indicates otherwise. The use of similar reference numerals across figures is intended to facilitate understanding of the relationships between components shown in different views or embodiments.

As used herein, a communication interface or connection point refers to a system or entry point configured to facilitate data exchange. A communication interface may encompass one or more communication ports that enable the transmission and reception of data.

As used herein, a communication port refers to a hardware or software interface configured to enable bi-directional data flow. A communication port may be adapted to transmit and receive Ethernet packets and may support one or more communication modes, including full duplex, where data transfer occurs simultaneously in both directions, or half duplex, where data transfer alternates between directions. A communication port may include physical circuits, logical pathways, or software components to manage the flow of Ethernet packets. A communication port may be implemented in devices such as network interfaces, switches, routers, or media converters. Examples of communication ports include bi-directional ports, which support alternating data flow, and full duplex ports, which enable simultaneous data flow in both directions.

As used herein, a full duplex port is a type of communication port and a specific type of bi-directional port that enables simultaneous bi-directional data flow in digital systems. A full duplex port configuration may improve communication efficiency by reducing latency, minimizing data collisions, and allowing uninterrupted data exchange in both directions. A full duplex port may enable simultaneous communication by transmitting and receiving data over separate channels, maintaining independent pathways for each direction. A full duplex port may include mechanisms or dedicated pathways, such as distinct physical or logical channels, to support simultaneous data flow. Full duplex ports may be suited for high-performance applications, such as Ethernet networks and other communication systems where low-latency, collision-free communication may be desired.

As used herein, a media independent interface (MII) is a standard interface used to connect a media access control (MAC) layer to a physical layer (PHY) in Ethernet devices. The MII allows the MAC layer, which is responsible for processing Ethernet frames, to communicate with the PHY layer, which handles the actual transmission and reception of data over physical media such as cables or wireless connections. Examples of MII include Gigabit MII (GMII) for 1 Gbps speeds, Reduced Gigabit MII (RGMII) for 1 Gbps with fewer pins, Serial Gigabit MII (SGMII) as a serial version of MII, and Reduced MII (RMII) as a simplified version with fewer pins for 100Base-T.

As used herein, a field-programmable gate array (FPGA) is an integrated circuit that can be configured by a customer or designer after manufacturing. An FPGA can be reprogrammed to perform a variety of functions, making FPGAs versatile for prototyping and custom applications. An FPGA may have a collection of configurable logic blocks (CLBs) that can implement complex combinational or sequential logic. Programmable interconnects may allow the CLBs to connect in various configurations. FPGAs may be capable of executing multiple processes in parallel, which may be advantageous for high-speed and low-latency tasks. Many FPGAs come with additional resources such as memory blocks, digital signal processing (DSP) slices, and sometimes embedded processors.

As used herein, a programmable logic device (PLD) is a category of electronic components that can be programmed to implement various digital logic functions. PLDs include a range of devices that allow users to configure the hardware after manufacturing, which provides flexibility for various applications. An FPGA is a subset of PLDs.

As used herein, an Ethernet packet processing device may be an Ethernet system level diagnostic and robustness tool.

As used herein, a configuration table is a data structure that may be stored in memory and that contains entries for different packet match criteria and corresponding packet manipulations to be performed. The packet match criteria may be based on various features of Ethernet packets, such as a subset of bits of a MAC destination address or other features in an Ethernet frame or packet format. The corresponding packet manipulations may include various operations to be performed on matched packets.

As used herein, a packet manipulation refers to an operation performed on an Ethernet packet. Packet manipulations may include packet content modification with cyclic redundancy check (CRC) update, packet termination, CRC corruption, or introducing a specified packet delay. Packet termination may occur by not forwarding a selected packet, interrupting a packet in mid-stream (runting), or selectively intermittently dropping a packet to simulate abnormal or failure conditions.

As used herein, minimal delay refers to processing delays that are substantially less than delays introduced by conventional approaches that operate at higher layers of the OSI model. In some cases, minimal delay may be less than 100 microseconds, less than 90 microseconds, less than 80 microseconds, less than 70 microseconds, less than 60 microseconds, less than 50 microseconds, less than 40 microseconds, less than 30 microseconds, less than 20 microseconds, less than 10 microseconds, less than 7 microseconds, less than 6 microseconds, less than 5 microseconds, or less than 3 microseconds in a network operating at a network speed of 100 megabits per second. In some cases, minimal delay may be about 2.6 microseconds. In some cases, minimal delay may be less than 2 microseconds at 1000Base-T Ethernet protocols.

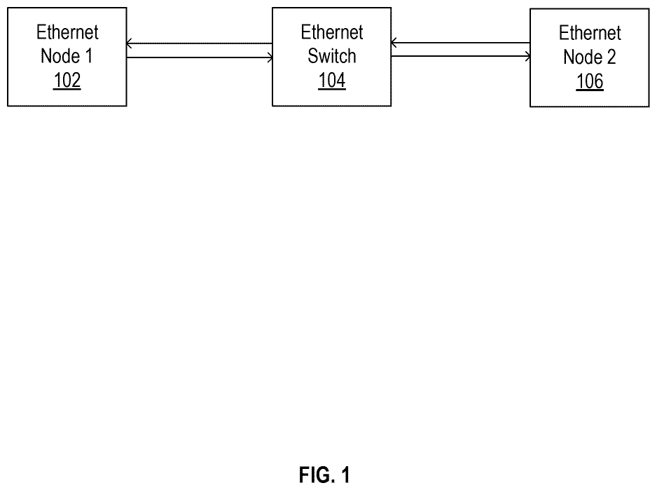

Referring to FIG. 1, a basic Ethernet network topology 100 is illustrated with two nodes connected via a switch. The network topology 100 comprises an Ethernet Node 1 102, an Ethernet Switch 104, and an Ethernet Node 2 106. The Ethernet Node 1 102 is positioned on the left side of the network topology 100 and is connected to the Ethernet Switch 104 through a bidirectional communication link. The Ethernet Switch 104 is positioned centrally within the network topology 100 and serves as an intermediary device that facilitates data transmission between the two end nodes. The Ethernet Switch 104 directs network traffic based on MAC addresses. The Ethernet Node 2 106 is positioned on the right side of the network topology 100 and is connected to the Ethernet Switch 104 through another bidirectional communication link. The bidirectional arrows between the components indicate that data can flow in both directions between the Ethernet Node 1 102 and the Ethernet Switch 104, as well as between the Ethernet Switch 104 and the Ethernet Node 2 106.

With continued reference to FIG. 1, in the network topology 100, the Ethernet Switch 104 mediates communication between the Ethernet Node 1 102 and the Ethernet Node 2 106. The Ethernet Node 1 102 and the Ethernet Node 2 106 may be various devices such as computers, servers, or other networked equipment. The network topology 100 may operate at different speeds depending on factors such as network requirements, hardware capabilities, and specific applications. In some cases, the network topology 100 may function at 10 megabits per second (e.g. 10Base-T). In some cases, the network topology 100 may operate at 100 megabits per second (e.g. 100Base-T). In some cases, the network topology 100 may operate at 1000 megabits per second (e.g. 1000Base-T), also known as Gigabit Ethernet. The basic network topology 100 provides a foundation for understanding more complex network configurations and the role of diagnostic and testing devices within such networks.

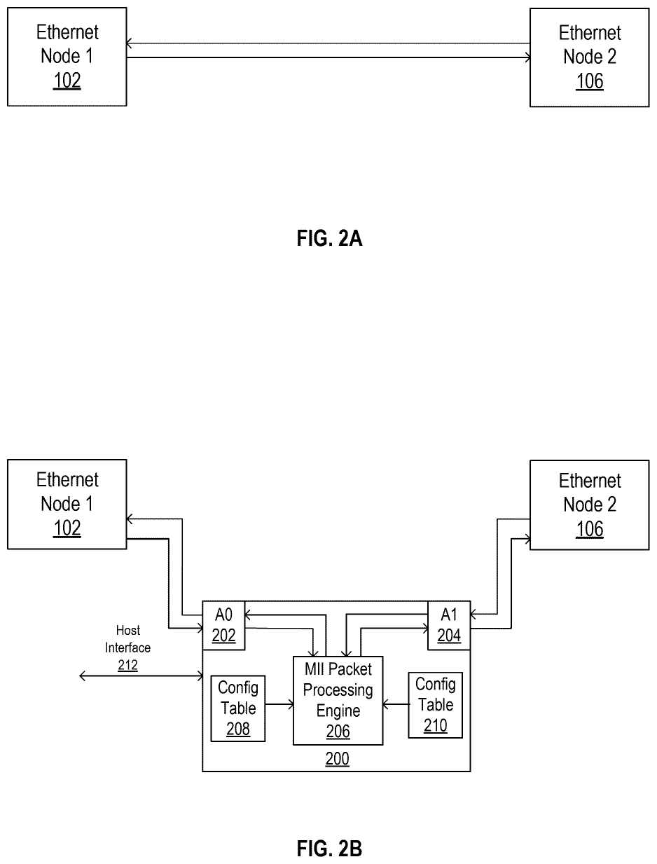

Referring to FIGS. 2A and 2B, block diagrams illustrate an Ethernet packet processing device 200 (e.g., MII packet processor) and the integration of the Ethernet packet processing device 200 into an Ethernet network connection between two Ethernet nodes. FIG. 2A depicts a direct connection between the Ethernet Node 1 102 and the Ethernet Node 2 106. FIG. 2B depicts the Ethernet packet processing device 200 positioned between the Ethernet Node 1 102 and the Ethernet Node 2 106, enabling packet processing operations on traffic flowing between the two nodes.

With continued reference to FIG. 2B, the Ethernet packet processing device 200 includes a first MII packet processor port 202 labeled A0 and a second MII packet processor port 204 labeled A1. The first MII packet processor port 202 is connected to the Ethernet Node 1 102, while the second MII packet processor port 204 is connected to the Ethernet Node 2 106. Both the first MII packet processor port 202 and the second MII packet processor port 204 are configured to receive and transmit Ethernet packets in a bidirectional manner. In some cases, the first MII packet processor port 202 and the second MII packet processor port 204 may be full duplex ports that enable simultaneous bi-directional data flow.

As further shown in FIG. 2B, an MII packet processing engine 206 is positioned at the center of the Ethernet packet processing device 200. The MII packet processing engine 206 performs packet inspection and manipulation operations on Ethernet packets received at the first MII packet processor port 202 and the second MII packet processor port 204. In some cases, the MII packet processing engine 206 may be implemented using a field-programmable gate array (FPGA). An FPGA is a subset of Programmable Logic Devices (PLDs) that can be configured by a customer or designer after manufacturing. The use of an FPGA may enable the MII packet processing engine 206 to execute multiple processes in parallel, which may be advantageous for high-speed and low-latency packet processing tasks.

With continued reference to FIG. 2B, the MII packet processing engine 206 is coupled to a configuration table 208 associated with the first MII packet processor port 202 and a configuration table 210 associated with the second MII packet processor port 204. The configuration table 208 and the configuration table 210 each store one or more packet match criteria and one or more corresponding packet manipulations that define how incoming packets are processed. In some cases, the packet match criteria may be based on a subset of bits of a MAC destination address of an Ethernet packet. In some cases, the match criteria may be the first 12 bits of the packet MAC destination address as defined as the Virtual Link (VL) identifier in the ARINC 664 Part 7 specification.

As further shown in FIG. 2B, an Ethernet packet received at the first MII packet processor port 202 may be processed according to the configuration table 208 and transmitted out of the second MII packet processor port 204. Similarly, an Ethernet packet received at the second MII packet processor port 204 may be processed according to the configuration table 210 and transmitted out of the first MII packet processor port 202. In some cases, if no match is found in the configuration table 208 or the configuration table 210, the Ethernet packet may be transmitted out of the other port to continue its original system route with minimal delay.

With continued reference to FIG. 2B, the Ethernet packet processing device 200 includes a host interface 212 connected to the MII packet processing engine 206. The host interface 212 allows for external configuration and monitoring of the Ethernet packet processing device 200. In some cases, the host interface 212 may enable users to load configuration tables into the Ethernet packet processing device 200. In some cases, the host interface 212 may enable users to adjust device behavior based on specific network testing or diagnostic requirements. In some cases, the configuration table 208 and the configuration table 210 may be recalled from non-volatile memory or downloaded from a host computer via the host interface 212.

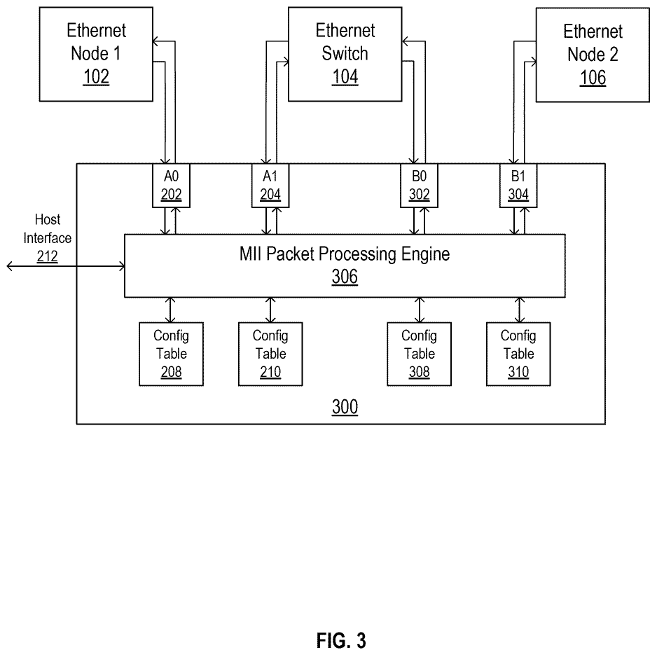

Referring to FIG. 3, a block diagram illustrates an Ethernet packet processing device 300 with a four-port configuration. The Ethernet packet processing device 300 interfaces with the Ethernet Node 1 102, the Ethernet Switch 104, and the Ethernet Node 2 106. The Ethernet packet processing device 300 includes the first MII packet processor port 202 labeled A0, the second MII packet processor port 204 labeled A1, a third MII packet processor port 302 labeled B0, and a fourth MII packet processor port 304 labeled B1.

With continued reference to FIG. 3, the Ethernet Node 1 102 connects to the first MII packet processor port 202. The Ethernet Switch 104 connects to both the second MII packet processor port 204 and the third MII packet processor port 302. The Ethernet Node 2 106 connects to the fourth MII packet processor port 304. This connection topology positions the Ethernet packet processing device 300 to interface with two separate network segments, with the first MII packet processor port 202 and the second MII packet processor port 204 forming a first port pair and the third MII packet processor port 302 and the fourth MII packet processor port 304 forming a second port pair.

As further shown in FIG. 3, an MII packet processing engine 306 is coupled to all four ports of the Ethernet packet processing device 300. The MII packet processing engine 306 performs packet inspection and manipulation operations on Ethernet packets received at the first MII packet processor port 202, the second MII packet processor port 204, the third MII packet processor port 302, and the fourth MII packet processor port 304. In some cases, the MII packet processing engine 306 may be implemented using a field-programmable gate array (FPGA).

With continued reference to FIG. 3, the Ethernet packet processing device 300 includes the configuration table 208 associated with the first MII packet processor port 202, the configuration table 210 associated with the second MII packet processor port 204, a configuration table 308 associated with the third MII packet processor port 302, and a configuration table 310 associated with the fourth MII packet processor port 304. Each of the configuration table 208, the configuration table 210, the configuration table 308, and the configuration table 310 stores one or more packet match criteria and one or more corresponding packet manipulations. The host interface 212 is coupled to the MII packet processing engine 306, allowing for external configuration and monitoring of the Ethernet packet processing device 300.

As further shown in FIG. 3, the four-port configuration of the Ethernet packet processing device 300 enables simultaneous monitoring and manipulation of traffic on two separate Ethernet links. In some cases, the four-port configuration may enable timing measurement between two segments in a network where the first MII packet processor port 202 and the second MII packet processor port 204 are inserted in one segment and the third MII packet processor port 302 and the fourth MII packet processor port 304 are inserted in another segment. This configuration may be useful in scenarios involving one or more switches for measuring transit delays on specific packets across multiple network segments.

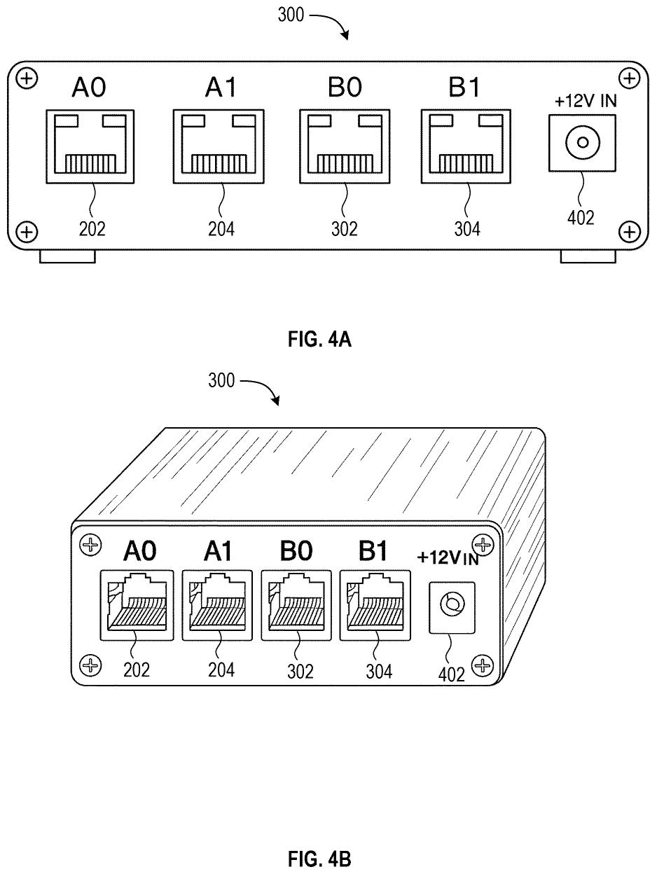

Referring to FIGS. 4A and 4B, orthogonal views of the Ethernet packet processing device 300 are illustrated. In some cases, the Ethernet packet processing device 300 may be configured for 10/100/1000Base-T Ethernet applications. FIG. 4A depicts a front panel view of the Ethernet packet processing device 300. FIG. 4B depicts an isometric view of the Ethernet packet processing device 300. The front panel of the Ethernet packet processing device 300 includes four Ethernet ports arranged in a row from left to right. The first MII packet processor port 202 labeled A0 is positioned on the far left side of the front panel. Adjacent to the first MII packet processor port 202 is the second MII packet processor port 204 labeled A1. To the right of the second MII packet processor port 204 is the third MII packet processor port 302 labeled B0. The fourth MII packet processor port 304 labeled B1 is positioned on the far right of the row of Ethernet ports.

With continued reference to FIG. 4A, each of the first MII packet processor port 202, the second MII packet processor port 204, the third MII packet processor port 302, and the fourth MII packet processor port 304 may be a standard RJ45 connector configured to accept Ethernet cables for network connections. A power input 402 labeled +12V IN is positioned on the right side of the front panel, adjacent to the fourth MII packet processor port 304. The power input 402 provides power to the Ethernet packet processing device 300.

As further shown in FIG. 4B, the isometric view reveals the three-dimensional form of the Ethernet packet processing device 300. The Ethernet packet processing device 300 may be housed in a rectangular enclosure with durable construction. In some cases, the enclosure may be made of metal construction with a brushed or matte finish. In some cases, the enclosure may be made of black anodized aluminum. The isometric view shows a top surface extending from the front panel of the Ethernet packet processing device 300. The front panel displays the same arrangement of ports as shown in FIG. 4A, including the first MII packet processor port 202 labeled A0, the second MII packet processor port 204 labeled A1, the third MII packet processor port 302 labeled B0, the fourth MII packet processor port 304 labeled B1, and the power input 402 labeled +12V IN.

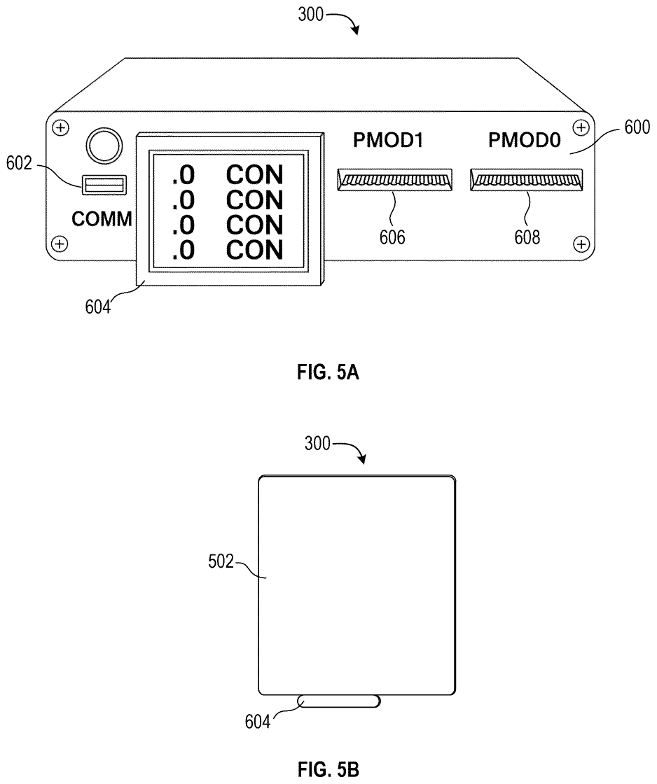

Referring to FIGS. 5A and 5B, orthogonal views of the Ethernet packet processing device 300 are illustrated. FIG. 5A depicts an orthogonal front view of the Ethernet packet processing device 300, and FIG. 5B depicts an orthogonal view of a top surface 502 of the Ethernet packet processing device 300. The Ethernet packet processing device 300 includes a front panel 600 that houses several interface elements for configuration and monitoring purposes.

With continued reference to FIG. 5A, a communication port 602 is positioned on the left side of the front panel 600. The communication port 602 may be used for connecting the Ethernet packet processing device 300 to external systems or for configuration purposes. In some cases, the communication port 602 may include an illuminated ring indicator. Adjacent to the communication port 602, a display screen 604 is provided on the front panel 600. The display screen 604 shows status indicators with values displayed, which may indicate connection status or operational parameters of the Ethernet packet processing device 300. In some cases, the display screen 604 may be a small LCD display screen. The display screen 604 may provide real-time visualization of packet flows and statistics, allowing users to monitor network activity directly from the Ethernet packet processing device 300.

As further shown in FIG. 5A, the front panel 600 includes a first expansion port 606 labeled PMOD1 and a second expansion port 608 labeled PMOD0 positioned on the right side of the front panel 600. The first expansion port 606 and the second expansion port 608 labeled PMOD0 may serve various functions, including connections for additional modules or interfaces. The front panel 600 is secured by screws positioned at the corners of the front panel 600.

Referring to FIG. 5B, the top surface 502 of the Ethernet packet processing device 300 presents a clean exterior. The display screen 604 is visible through an opening in the top surface 502. The front panel 600 is shown at the bottom edge of the view in FIG. 5B. In some cases, the top surface 502 may feature branding and decorative elements. In some cases, the top surface 502 may feature a logo and branding text with decorative circuit trace-like lines, suggesting the electronic nature of the Ethernet packet processing device 300.

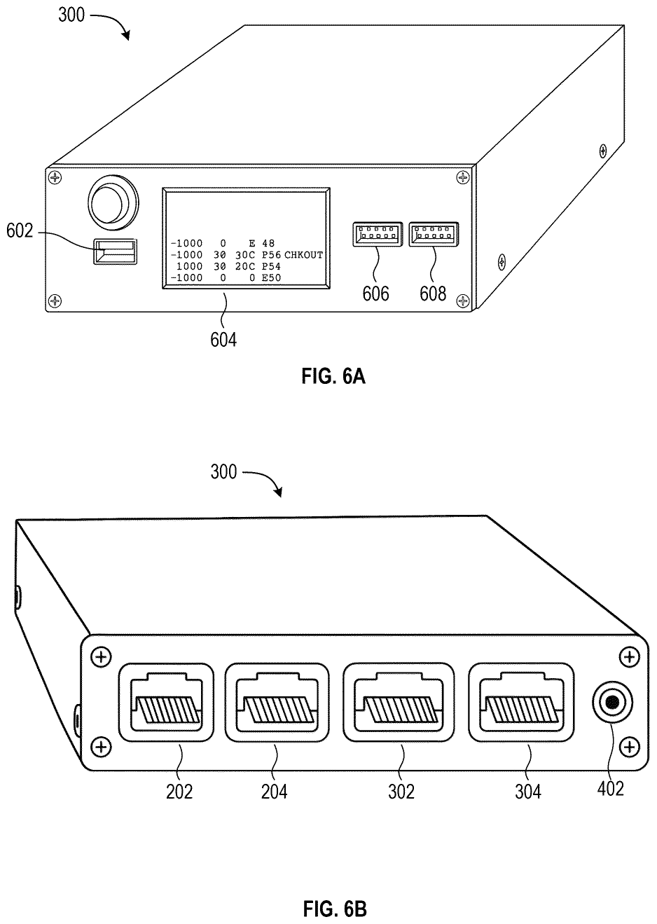

Referring to FIGS. 6A and 6B, an isometric view of the front panel and an orthogonal rear view of the Ethernet packet processing device 300 are illustrated. In some cases, the Ethernet packet processing device 300 may be configured as an automotive variant designed for 100/1000Base-T1 automotive Ethernet applications. FIG. 6A depicts an isometric view of the front panel of the Ethernet packet processing device 300, and FIG. 6B depicts an orthogonal rear view of the Ethernet packet processing device 300. The isometric view in FIG. 6A shows the communication port 602 positioned on the left side of the front panel. The communication port 602 may be used for connecting the Ethernet packet processing device 300 to external systems or for configuration purposes.

With continued reference to FIG. 6A, the display screen 604 is positioned adjacent to the communication port 602. The display screen 604 displays numerical values and text indicators that provide real-time visualization of packet flows and device status. The display screen 604 may show status information and operational parameters of the Ethernet packet processing device 300, allowing users to monitor network activity directly from the Ethernet packet processing device 300.

As further shown in FIG. 6A, the first expansion port 606 and a second expansion port 608 are positioned to the right of the display screen 604. The first expansion port 606 and the second expansion port 608 may serve various functions, including connections for additional modules or interfaces. In some cases, the first expansion port 606 and the second expansion port 608 may enable expansion of the capabilities of the Ethernet packet processing device 300 through connection of external modules.

Referring to FIG. 6B, the rear panel of the Ethernet packet processing device 300 shows the first MII packet processor port 202, the second MII packet processor port 204, the third MII packet processor port 302, and the fourth MII packet processor port 304 arranged in a row. In some cases, the ports may comprise MATEnet connectors, which are automotive-grade Ethernet connectors designed for 100Base-T1 and 1000Base-T1 applications in vehicles. In some cases, the MATEnet connectors may enable the Ethernet packet processing device 300 to connect directly to automotive Ethernet networks using standardized automotive connectors. Each of the first MII packet processor port 202, the second MII packet processor port 204, the third MII packet processor port 302, and the fourth MII packet processor port 304 is configured to receive and transmit Ethernet packets. The four-port configuration enables the Ethernet packet processing device 300 to simultaneously monitor and manipulate traffic on two separate Ethernet links, facilitating network diagnostics and robustness testing across multiple network segments.

With continued reference to FIG. 6B, the power input 402 is positioned on the right side of the rear panel adjacent to the fourth MII packet processor port 304. The power input 402 provides power to the Ethernet packet processing device 300. In some cases, the Ethernet packet processing device 300 may support IEEE 802.3bw (100Base-T1) and IEEE 802.3 bp (1000Base-T1) standards for automotive Ethernet over single twisted pair cabling. In some cases, the Ethernet packet processing device 300 may include a configuration system for remote configuration and monitoring. The configuration system may comprise a web-based interface or a dedicated mobile application. Such a configuration system may enable users to adjust settings, view statistics, and manage operations of the Ethernet packet processing device 300 from a remote location, enhancing flexibility and usability of the Ethernet packet processing device 300 in various network environments.

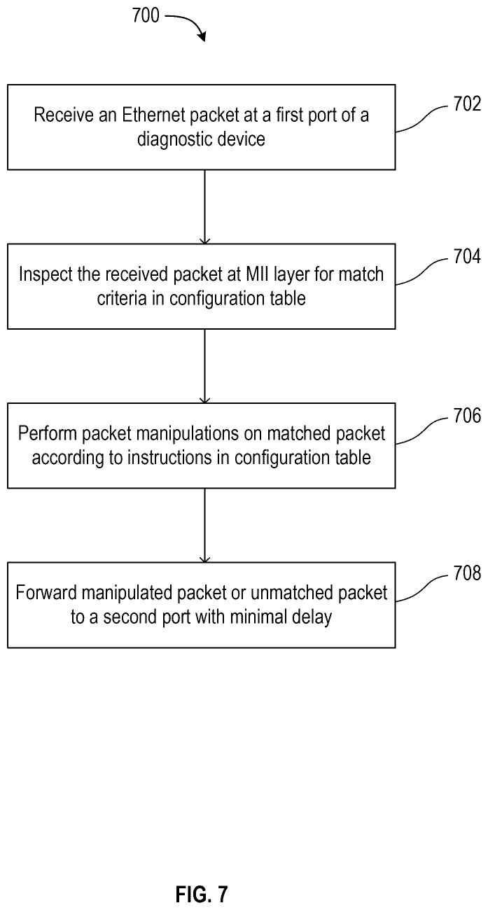

Referring to FIG. 7, a flowchart illustrates a method 700 for processing Ethernet packets in a diagnostic device. The method 700 provides a structured approach for real-time packet inspection and manipulation at the MII layer, enabling efficient network diagnostics and robustness testing. The method 700 includes a series of steps that outline the packet handling process from reception through inspection, matching, manipulation, and transmission.

With continued reference to FIG. 7, the method 700 begins with a step 702, where an Ethernet packet is received at a first port of a diagnostic device. The step 702 initiates the packet processing sequence. The first port may be any port configured to receive inbound Ethernet packets, such as the first MII packet processor port 202 or the second MII packet processor port 204 in the Ethernet packet processing device 300. In some cases, the first port may be the third MII packet processor port 302 or the fourth MII packet processor port 304. The Ethernet packet received at the step 702 may originate from various sources within an Ethernet network, such as network devices, servers, or other network nodes.

As further shown in FIG. 7, following the reception of the Ethernet packet at the step 702, the method 700 proceeds to a step 704. At the step 704, the received Ethernet packet is inspected at the MII layer for match criteria in a configuration table. The inspection at the step 704 allows the diagnostic device to determine if the Ethernet packet requires any specific handling. In some cases, the inspection at the step 704 may involve examining the first 12 bits of the MAC destination address of the Ethernet packet. In some cases, the inspection at the step 704 may involve examining other unique features in the Ethernet frame or packet format as defined by IEEE 802.3. In some cases, the Ethernet packet processing device 300 may inspect the MAC source address as an alternative packet match criterion instead of or in addition to the MAC destination address. In some cases, the Ethernet packet processing device 300 may inspect an optional 802.1Q tag as an alternative packet match criterion instead of or in addition to the MAC destination address. In some cases, the Ethernet packet processing device 300 may inspect an Ethertype field as an alternative packet match criterion instead of or in addition to the MAC destination address. This flexibility in packet match criteria allows the Ethernet packet processing device 300 to handle a wide range of Ethernet packets and perform various operations based on specific features of each packet.

With continued reference to FIG. 7, if a match is found in the configuration table at the step 704, the method 700 moves to a step 706. At the step 706, packet manipulations are performed on the matched packet according to instructions specified in the configuration table. The packet manipulations at the step 706 may include content modification with cyclic redundancy check (CRC) update, packet termination, CRC corruption, and specified delays, all with minimal additional delay. The specific manipulations performed at the step 706 may depend on the match criteria and the corresponding instructions in the configuration table 208, the configuration table 210, the configuration table 308, or the configuration table 310.

As further shown in FIG. 7, packet termination at the step 706 may occur in one of three ways. In some cases, packet termination may occur by not forwarding the selected packet at all. In some cases, packet termination may occur by interrupting the packet in mid-stream, which may be referred to as runting. In some cases, packet termination may occur by selectively intermittently dropping the packet to simulate abnormal or failure conditions. These different modes of packet termination allow the Ethernet packet processing device 300 to test the robustness and performance of a network under various conditions.

With continued reference to FIG. 7, at a step 708, the manipulated packet, if a match was found and manipulations were performed at the step 706, or an unmatched packet, if no match was found in the configuration table at the step 704, is forwarded to a second port with minimal delay. The step 708 ensures that the Ethernet packet continues its journey through the network with minimal interruption. The second port may be any port configured to transmit outbound Ethernet packets, such as the second MII packet processor port 204 when the Ethernet packet was received at the first MII packet processor port 202, or the first MII packet processor port 202 when the Ethernet packet was received at the second MII packet processor port 204. In some cases, the second port may be the fourth MII packet processor port 304 when the Ethernet packet was received at the third MII packet processor port 302, or the third MII packet processor port 302 when the Ethernet packet was received at the fourth MII packet processor port 304. The minimal delay at the step 708 may be less than 6 microseconds in a network operating at a network speed of 100 megabits per second.

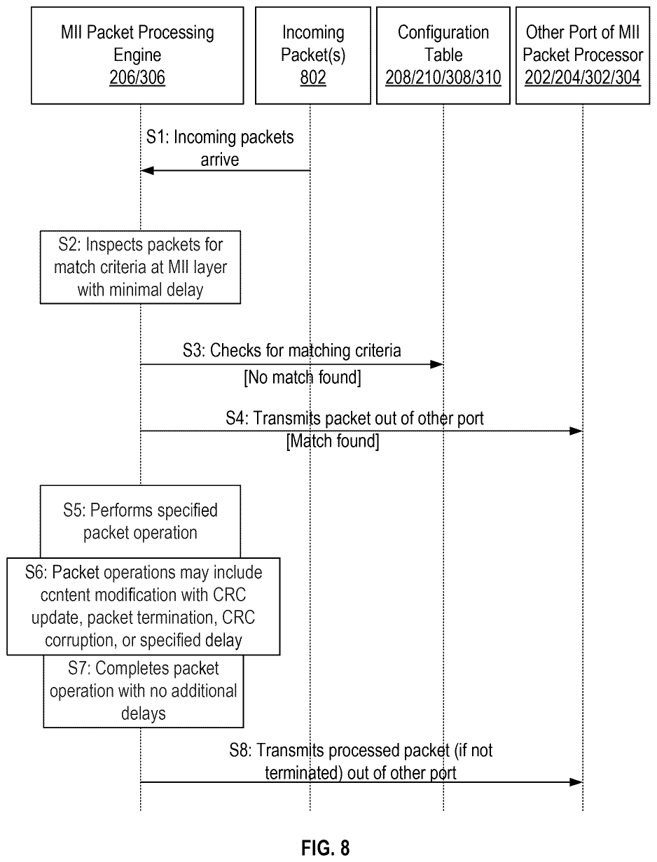

Referring to FIG. 8, a sequence diagram illustrates a packet processing workflow in an MII packet processor. The sequence diagram depicts interactions between the MII packet processing engine 206, incoming packets 802, the configuration table 208, the configuration table 210, and the second MII packet processor port 204. The sequence diagram also references elements associated with a four-port configuration including the third MII packet processor port 302, the fourth MII packet processor port 304, the MII packet processing engine 306, the configuration table 308, and the configuration table 310.

With continued reference to FIG. 8, the packet processing workflow begins with step S1, where the incoming packets 802 arrive at the MII packet processing engine 206. The incoming packets 802 may originate from various sources within an Ethernet network, such as network devices, servers, or other network nodes. The incoming packets 802 may be received at the first MII packet processor port 202, the second MII packet processor port 204, the third MII packet processor port 302, or the fourth MII packet processor port 304.

As further shown in FIG. 8, in step S2, the MII packet processing engine 206 inspects the incoming packets 802 for match criteria at the MII layer with minimal delay. The inspection at step S2 involves examining a subset of bits of the MAC destination address of each packet in the incoming packets 802. In some cases, the subset of bits may comprise the first 12 bits of the MAC destination address. The inspection at the MII layer enables the MII packet processing engine 206 to perform rapid packet analysis without introducing delays associated with processing at higher layers of the OSI model.

With continued reference to FIG. 8, in step S3, the MII packet processing engine 206 checks for matching criteria against the configuration table 208 or the configuration table 210. The MII packet processing engine 206 compares the inspected bits from step S2 against the one or more packet match criteria stored in the configuration table 208 or the configuration table 210 to determine whether each packet in the incoming packets 802 is a matched packet when a match is found or an unmatched packet when no match is found.

As further shown in FIG. 8, the sequence diagram branches into two alternative paths based on whether a match is found at step S3. If no match is found, the packet processing workflow proceeds to step S4, where the packet is transmitted out of the second MII packet processor port 204 or another port of the Ethernet packet processing device 200 without any modifications. The transmission at step S4 occurs with minimal delay, allowing unmatched packets to continue their original system routes with minimal interruption.

With continued reference to FIG. 8, if a match is found at step S3, the packet processing workflow continues to step S5, where the MII packet processing engine 206 performs a specified packet operation on the matched packet. Step S6 indicates that packet operations may include content modification with CRC update, packet termination, CRC corruption, or a specified delay. In step S7, the MII packet processing engine 206 completes the packet operation with no additional delays beyond the minimal delay introduced by the MII layer processing.

As further shown in FIG. 8, in step S8, the processed packet, if not terminated, is transmitted out of the second MII packet processor port 204 or another appropriate port of the Ethernet packet processing device 200. The transmission at step S8 occurs with minimal delay. In some cases, the minimal delay may be less than 100 microseconds, less than 90 microseconds, less than 80 microseconds, less than 70 microseconds, less than 60 microseconds, less than 50 microseconds, less than 40 microseconds, less than 30 microseconds, less than 20 microseconds, less than 10 microseconds, less than 5 microseconds, or less than 3 microseconds in a network operating at a network speed of 100 megabits per second. In some cases, the minimal delay may be about 2.6 microseconds when operating at 100 megabits per second network speed. In some cases, the Ethernet packet processing device 300 may execute full duplex operations at the MII level on Ethernet links and introduce delays less than 7 microseconds at 100Base-T and less than 2 microseconds at 1000Base-T Ethernet protocols.

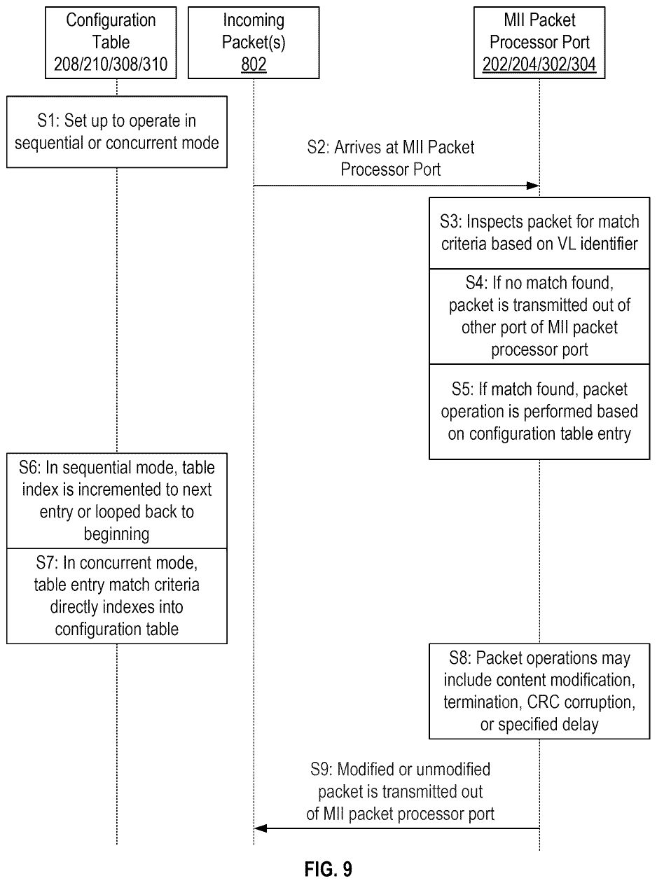

Referring to FIG. 9, a sequence diagram illustrates a packet processing workflow in an MII packet processor with sequential and concurrent operating modes. The sequence diagram depicts interactions between the configuration table 208, the configuration table 210, the configuration table 308, the configuration table 310, the incoming packets 802, and the first MII packet processor port 202, the second MII packet processor port 204, the third MII packet processor port 302, and the fourth MII packet processor port 304. The sequence diagram illustrates how the Ethernet packet processing device 300 may operate in either a sequential mode or a concurrent mode based on settings in the configuration tables.

With continued reference to FIG. 9, in step S1, the configuration table 208, the configuration table 210, the configuration table 308, or the configuration table 310 is set up to operate in sequential mode or concurrent mode. The configuration tables may be recalled from non-volatile memory. In some cases, the non-volatile memory may be flash memory, read-only memory (ROM), electrically erasable programmable read-only memory (EEPROM), ferroelectric RAM (FRAM), magnetoresistive RAM (MRAM), phase-change memory (PCM), resistive RAM (RRAM), or 3D XPoint memory. In some cases, the configuration tables may be downloaded from a host computer via the host interface 212. The host computer may be a personal computer, a server, a laptop, a tablet, a smartphone, or any other type of computing device. The configuration tables may be downloaded from the host computer via a network connection, a USB connection, a serial connection, a parallel connection, or any other type of connection.

As further shown in FIG. 9, in step S2, the incoming packets 802 arrive at the first MII packet processor port 202, the second MII packet processor port 204, the third MII packet processor port 302, or the fourth MII packet processor port 304. The incoming packets 802 may originate from various sources within an Ethernet network, such as network devices, servers, or other network nodes.

With continued reference to FIG. 9, in step S3, the first MII packet processor port 202, the second MII packet processor port 204, the third MII packet processor port 302, or the fourth MII packet processor port 304 inspects each packet in the incoming packets 802 for match criteria based on a Virtual Link (VL) identifier. The VL identifier may comprise the first 12 bits of the MAC destination address as defined in the ARINC 664 Part 7 specification. Using the VL identifier may minimize transport delay within the Ethernet packet processing device 300 and may enable compatibility with existing higher level network traffic configuration and scheduling tools. In some cases, the Ethernet packet processing device 300 may interface with a higher level tool to modify parameters by name rather than a bit stream in a packet.

As further shown in FIG. 9, in step S4, if no match is found at step S3, the packet is transmitted out of another port of the Ethernet packet processing device 300. In some cases, when a packet is received at the first MII packet processor port 202 and no match is found, the packet may be transmitted out of the second MII packet processor port 204. In some cases, when a packet is received at the second MII packet processor port 204 and no match is found, the packet may be transmitted out of the first MII packet processor port 202. In some cases, when a packet is received at the third MII packet processor port 302 and no match is found, the packet may be transmitted out of the fourth MII packet processor port 304. In some cases, when a packet is received at the fourth MII packet processor port 304 and no match is found, the packet may be transmitted out of the third MII packet processor port 302. The transmission at step S4 occurs with minimal delay, allowing unmatched packets to continue their original system routes.

With continued reference to FIG. 9, in step S5, if a match is found at step S3, a packet operation is performed based on a configuration table entry in the configuration table 208, the configuration table 210, the configuration table 308, or the configuration table 310. The packet operation performed at step S5 may depend on the match criteria and the corresponding instructions stored in the configuration table entry.

As further shown in FIG. 9, in step S6, when operating in sequential mode, a table index is incremented to a next entry in the configuration table 208, the configuration table 210, the configuration table 308, or the configuration table 310 after performing a packet manipulation. In some cases, the table index may be looped back to the beginning of the configuration table after reaching the last entry. The sequential mode may be useful for detecting events that occur in a specific order. In some cases, the Ethernet packet processing device 300 may be configured to inspect packets for a specific MAC destination address, perform a packet manipulation if a match is found, and then move on to the next entry in the configuration table to inspect for a different MAC destination address. This sequential processing may be repeated for all entries in the configuration table, allowing the Ethernet packet processing device 300 to handle a wide range of packet types and perform various operations based on specific features of each packet in a defined sequence.

With continued reference to FIG. 9, in step S7, when operating in concurrent mode, table entry match criteria directly indexes into the configuration table 208, the configuration table 210, the configuration table 308, or the configuration table 310. The concurrent mode allows the Ethernet packet processing device 300 to process multiple packets simultaneously, enhancing packet processing efficiency. In some cases, the Ethernet packet processing device 300 may be configured to inspect packets for multiple MAC destination addresses at the same time, perform packet manipulations if matches are found, and forward the manipulated or unmatched packets with minimal delay. This concurrent processing may be performed for all packets in the incoming packets 802, allowing the Ethernet packet processing device 300 to handle high-volume network traffic and perform various operations in real-time.

As further shown in FIG. 9, in step S8, packet operations may include content modification with CRC update, packet termination, CRC corruption, or a specified delay. The content modification may involve changing data within the payload of the Ethernet packet and recalculating the CRC to maintain packet integrity. The packet termination may involve not forwarding the packet, interrupting the packet in mid-stream, or selectively intermittently dropping the packet. The CRC corruption may involve intentionally corrupting the CRC value to test how network devices respond to packets with invalid checksums. The specified delay may involve holding the packet for a defined period before forwarding to test network timing behavior.

With continued reference to FIG. 9, in step S9, the modified or unmodified packet is transmitted out of the appropriate port of the Ethernet packet processing device 300. In some cases, the Ethernet packet processing device 300 may switch between the sequential mode and the concurrent mode based on network conditions or specific requirements of network diagnostics or robustness testing scenarios. This flexibility in operating modes allows the Ethernet packet processing device 300 to adapt to varying network conditions and perform efficient and effective packet processing in a wide range of applications.

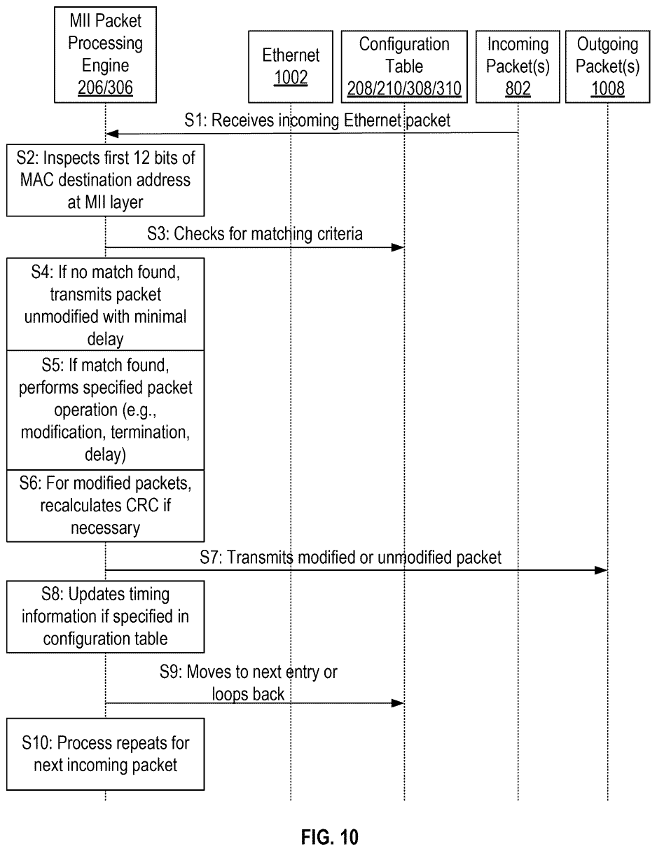

Referring to FIG. 10, a sequence diagram illustrates a packet processing workflow 1000 performed by an MII packet processor. The sequence diagram depicts interactions between the MII packet processing engine 206 or the MII packet processing engine 306, an Ethernet 1002, the configuration table 208, the configuration table 210, the configuration table 308, the configuration table 310, the incoming packets 802, and outgoing packets 1008. The packet processing workflow 1000 illustrates the flow of Ethernet packets from reception through inspection, matching, manipulation, and transmission.

With continued reference to FIG. 10, the packet processing workflow 1000 begins with step S1, where the MII packet processing engine 206 or the MII packet processing engine 306 receives an incoming Ethernet packet from the incoming packets 802 via the Ethernet 1002. The incoming Ethernet packet may originate from various sources within an Ethernet network, such as network devices, servers, or other network nodes. The incoming Ethernet packet may be received at the first MII packet processor port 202, the second MII packet processor port 204, the third MII packet processor port 302, or the fourth MII packet processor port 304.

As further shown in FIG. 10, at step S2, the MII packet processing engine 206 or the MII packet processing engine 306 inspects the first 12 bits of the MAC destination address of the incoming Ethernet packet at the MII layer. The inspection at step S2 occurs at the MII layer, which enables the MII packet processing engine 206 or the MII packet processing engine 306 to perform rapid packet analysis without introducing delays associated with processing at higher layers of the OSI model. In some cases, the first 12 bits of the MAC destination address may correspond to a Virtual Link (VL) identifier as defined in the ARINC 664 Part 7 specification.

With continued reference to FIG. 10, at step S3, the MII packet processing engine 206 or the MII packet processing engine 306 checks for matching criteria against the configuration table 208, the configuration table 210, the configuration table 308, or the configuration table 310. The MII packet processing engine 206 or the MII packet processing engine 306 compares the inspected bits from step S2 against the one or more packet match criteria stored in the configuration table to determine whether the incoming Ethernet packet is a matched packet when a match is found or an unmatched packet when no match is found.

As further shown in FIG. 10, at step S4, if no match is found at step S3, the MII packet processing engine 206 or the MII packet processing engine 306 transmits the packet unmodified with minimal delay. The transmission at step S4 allows unmatched packets to continue their original system routes with minimal interruption. In some cases, the minimal delay at step S4 may be less than 6 microseconds in a network operating at a network speed of 100 megabits per second.

With continued reference to FIG. 10, at step S5, if a match is found at step S3, the MII packet processing engine 206 or the MII packet processing engine 306 performs a specified packet operation according to the configuration table 208, the configuration table 210, the configuration table 308, or the configuration table 310. The specified packet operation at step S5 may include modification of packet content, termination of the packet, or introduction of a delay. In some cases, the specified packet operation may include CRC corruption to test how network devices respond to packets with invalid checksums.

As further shown in FIG. 10, at step S6, the MII packet processing engine 206 or the MII packet processing engine 306 recalculates the CRC if the packet content has been modified at step S5. The recalculation of the CRC at step S6 maintains packet integrity for modified packets, ensuring that downstream network devices can properly validate the modified packet. In some cases, the CRC recalculation may be performed in real-time as part of the packet manipulation process.

With continued reference to FIG. 10, at step S7, the MII packet processing engine 206 or the MII packet processing engine 306 transmits the modified or unmodified packet to the outgoing packets 1008. The transmission at step S7 occurs with minimal delay. In some cases, the modified packet may be transmitted out of the second MII packet processor port 204 when the incoming Ethernet packet was received at the first MII packet processor port 202. In some cases, the modified packet may be transmitted out of the first MII packet processor port 202 when the incoming Ethernet packet was received at the second MII packet processor port 204. In some cases, the modified packet may be transmitted out of the fourth MII packet processor port 304 when the incoming Ethernet packet was received at the third MII packet processor port 302. In some cases, the modified packet may be transmitted out of the third MII packet processor port 302 when the incoming Ethernet packet was received at the fourth MII packet processor port 304.

As further shown in FIG. 10, at step S8, the MII packet processing engine 206 or the MII packet processing engine 306 updates timing information if specified in the configuration table 208, the configuration table 210, the configuration table 308, or the configuration table 310. In some cases, the Ethernet packet processing device 300 may include a plurality of independent timers that can be activated to measure timing between packets. In some cases, the plurality of independent timers may comprise 2 to 100 timers. In some cases, the plurality of independent timers may comprise 2 to 20 timers. In some cases, the plurality of independent timers may comprise 5 to 15 timers. In some cases, the plurality of independent timers may comprise 8 timers. Each configuration table entry may turn on or off one or more of the plurality of independent timers to measure timing between any two incoming packets.

With continued reference to FIG. 10, the timing information generated by the plurality of independent timers may be represented in 32 bits with an 8 nanosecond resolution. In some cases, the timing information may be transmitted to a host computer via the host interface 212 for further analysis. In some cases, the timing information may be depicted as an electrical pulse whose width is the actual delay in time. The electrical pulse representation may provide a visual indication of the timing between packets, which may be useful for network administrators or technicians in diagnosing network issues or optimizing network performance.

As further shown in FIG. 10, the plurality of independent timers may be used to measure equipment response time between a stimulus and a response. In some cases, the stimulus may comprise data reception at one of the first MII packet processor port 202, the second MII packet processor port 204, the third MII packet processor port 302, or the fourth MII packet processor port 304. In some cases, the response may comprise data processing and transmission from one of the first MII packet processor port 202, the second MII packet processor port 204, the third MII packet processor port 302, or the fourth MII packet processor port 304. The plurality of independent timers may also be used to measure transit delay and jitter within a network. In some cases, the transit delay measurement may involve measuring the time for a packet to travel between two points in the network. In some cases, the jitter measurement may involve measuring variations in packet arrival times.

With continued reference to FIG. 10, at step S9, the process moves to a next entry in the configuration table 208, the configuration table 210, the configuration table 308, or the configuration table 310, or loops back to the beginning of the configuration table. The movement to the next entry at step S9 may occur when operating in sequential mode. In some cases, the table index may be incremented to the next entry after performing a packet manipulation. In some cases, the table index may be looped back to the beginning of the configuration table after reaching the last entry.

As further shown in FIG. 10, at step S10, the packet processing workflow 1000 repeats for the next incoming packet from the incoming packets 802. The repetition at step S10 enables continuous network monitoring and manipulation as specified by the configuration table 208, the configuration table 210, the configuration table 308, or the configuration table 310. The packet processing workflow 1000 may continue to process packets in the incoming packets 802 until the Ethernet packet processing device 300 is powered off or reconfigured.

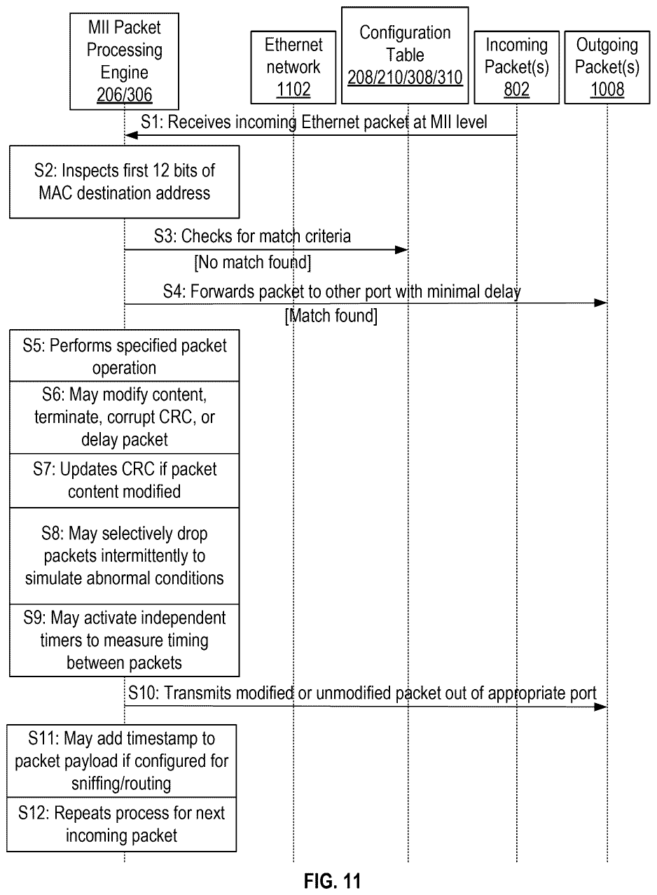

Referring to FIG. 11, a sequence diagram illustrates a packet processing flow in an MII packet processor device. The sequence diagram depicts interactions between the MII packet processing engine 206, the configuration table 208, the configuration table 210, an Ethernet network 1102, the incoming packets 802, and the outgoing packets 1008. The sequence diagram illustrates advanced packet processing and timing features of the Ethernet packet processing device 300, including selective packet dropping, timer activation, and timestamp insertion capabilities.

With continued reference to FIG. 11, the packet processing flow begins with step S1, where the MII packet processing engine 206 receives an incoming Ethernet packet at the MII level from the incoming packets 802. The incoming Ethernet packet may originate from various sources within the Ethernet network 1102, such as network devices, servers, or other network nodes. The reception at the MII level enables the MII packet processing engine 206 to process the incoming Ethernet packet with minimal delay compared to processing at higher layers of the OSI model.

As further shown in FIG. 11, at step S2, the MII packet processing engine 206 inspects the first 12 bits of the MAC destination address of the received Ethernet packet. The first 12 bits of the MAC destination address may correspond to a Virtual Link (VL) identifier as defined in the ARINC 664 Part 7 specification. The inspection of the first 12 bits at step S2 enables rapid identification of packets of interest without requiring examination of the entire packet.

With continued reference to FIG. 11, at step S3, the MII packet processing engine 206 checks for match criteria against the configuration table 208 or the configuration table 210. The MII packet processing engine 206 compares the inspected bits from step S2 against the one or more packet match criteria stored in the configuration table 208 or the configuration table 210 to determine whether the Ethernet packet is a matched packet when a match is found or an unmatched packet when no match is found.

As further shown in FIG. 11, the sequence diagram branches into two alternative paths based on whether a match is found at step S3. If no match is found, the packet processing flow proceeds to step S4, where the Ethernet packet is forwarded to another port with minimal delay. In some cases, when a packet is received at the first MII packet processor port 202 and no match is found, the packet may be forwarded to the second MII packet processor port 204. In some cases, when a packet is received at the second MII packet processor port 204 and no match is found, the packet may be forwarded to the first MII packet processor port 202. The forwarding at step S4 allows unmatched packets to continue their original system routes with minimal interruption.

With continued reference to FIG. 11, if a match is found at step S3, the packet processing flow continues to step S5, where the MII packet processing engine 206 performs a specified packet operation on the matched Ethernet packet. The specified packet operation at step S5 may be defined by the corresponding packet manipulations stored in the configuration table 208 or the configuration table 210.

As further shown in FIG. 11, at step S6, the MII packet processing engine 206 may modify content of the matched Ethernet packet, terminate the matched Ethernet packet, corrupt the CRC of the matched Ethernet packet, or delay the matched Ethernet packet. The content modification may involve changing data within the payload of the Ethernet packet. The packet termination may involve not forwarding the packet, interrupting the packet in mid-stream, or selectively intermittently dropping the packet. The CRC corruption may involve intentionally corrupting the CRC value to test how network devices respond to packets with invalid checksums. The delay may involve holding the packet for a defined period before forwarding to test network timing behavior.

With continued reference to FIG. 11, at step S7, the MII packet processing engine 206 updates the CRC if the content of the Ethernet packet has been modified at step S6. The CRC update at step S7 maintains packet integrity for modified packets, ensuring that downstream network devices can properly validate the modified packet. In some cases, the CRC update may be performed in real-time as part of the packet manipulation process.

As further shown in FIG. 11, at step S8, the MII packet processing engine 206 may selectively drop packets intermittently to simulate abnormal conditions. The selective intermittent dropping of packets at step S8 allows the Ethernet packet processing device 300 to test the robustness and performance of the Ethernet network 1102 under various failure conditions. In some cases, the frequency and pattern of packet dropping may be configured based on specific requirements of network diagnostics or robustness testing scenarios. The selective intermittent dropping may be used to simulate network errors or failures and observe how the Ethernet network 1102 responds to these simulated conditions.

With continued reference to FIG. 11, at step S9, the MII packet processing engine 206 may activate independent timers to measure timing between packets. In some cases, the Ethernet packet processing device 300 may include a plurality of independent timers that can be activated based on instructions in the configuration table 208 or the configuration table 210. Each configuration table entry may turn on or off one or more of the plurality of independent timers to measure timing between any two incoming packets. The plurality of independent timers may be used to measure transit delay and jitter within the Ethernet network 1102, measure timing between two different packets on the Ethernet network 1102, or measure equipment response time between receiving one packet and transmitting another packet.

As further shown in FIG. 11, at step S10, the MII packet processing engine 206 transmits the modified or unmodified Ethernet packet out of the appropriate port as the outgoing packets 1008. The transmission at step S10 occurs with minimal delay. In some cases, the modified or unmodified Ethernet packet may be transmitted out of the second MII packet processor port 204 when the incoming Ethernet packet was received at the first MII packet processor port 202. In some cases, the modified or unmodified Ethernet packet may be transmitted out of the first MII packet processor port 202 when the incoming Ethernet packet was received at the second MII packet processor port 204.

With continued reference to FIG. 11, at step S11, the MII packet processing engine 206 may add a timestamp to the packet payload if configured for sniffing or routing. In some cases, the Ethernet packet processing device 300 may replicate or route traffic from the first MII packet processor port 202 and the second MII packet processor port 204 to the third MII packet processor port 302 and the fourth MII packet processor port 304 to support seamless monitoring by other equipment. This sniffing functionality may be useful for bidirectional wire Ethernet protocols such as 10Base-T, 100Base-T, 1000Base-T, 100Base-T1, and 1000Base-T1. In some cases, the sniffing functionality may be performed selectively on selected packets as defined in the configuration table 208 or the configuration table 210.

As further shown in FIG. 11, a 4-byte free running timestamp may be inserted at a user-defined location in the routed or sniffed packet payload. The timestamp may indicate the time of arrival of the Ethernet packet at the Ethernet packet processing device 300. In some cases, the Ethernet packet processing device 300 may include an internal oscillator for generating the timestamp. The internal oscillator may be synchronized to a particular received packet periodically. The synchronization of the internal oscillator to a particular received packet may be useful for diagnostic and robustness testing of synchronous Ethernet networks such as Time-Triggered Ethernet (TTE). In some cases, the timestamp synchronization accuracy may vary based on specific requirements of network diagnostics or robustness testing scenarios. In some cases, the Ethernet packet processing device 300 may achieve a timestamp synchronization accuracy of up to 8 nanoseconds.

With continued reference to FIG. 11, at step S12, the packet processing flow repeats for the next incoming packet from the incoming packets 802. The repetition at step S12 enables continuous network monitoring and manipulation as specified by the configuration table 208 or the configuration table 210. The packet processing flow may continue to process packets in the incoming packets 802 until the Ethernet packet processing device 300 is powered off or reconfigured. The sequence diagram of FIG. 11 illustrates the interaction flow between the MII packet processing engine 206, the configuration table 208, the configuration table 210, the Ethernet network 1102, the incoming packets 802, and the outgoing packets 1008, highlighting the steps involved in the packet processing workflow including advanced features such as selective packet dropping, timer activation, and timestamp insertion.

Table 1 illustrates the structure of an Ethernet frame and packet according to IEEE 802.3 standards. As shown in Table 1, the Layer 2 Ethernet frame comprises several fields, including a 7-octet Preamble, a 1-octet Start Frame Delimiter (SFD), a 6-octet MAC destination address, a 6-octet MAC source address, an optional 4-octet 802.1Q tag, a 2-octet Ethertype (Ethernet II) or length (IEEE 802.3) field, a variable Payload of 42-1500 octets, and a 4-octet Frame Check Sequence (32-bit CRC). The Preamble, SFD, and Interpacket Gap (IPG) are not considered part of the Layer 2 frame. The total Layer 2 Ethernet frame spans 64-1522 octets. The Layer 1 Ethernet packet encompasses the entire frame and ranges from 64-1522 octets, followed by a 12-octet IPG. As described above with reference to FIGS. 7-11, the Ethernet packet processing device 300 may inspect the first 12 bits of the MAC destination address field to identify packets of interest for real-time inspection and manipulation with minimal delay. In some cases, the Ethernet packet processing device 300 may inspect other fields shown in Table 1, such as the MAC source address, the optional 802.1Q tag, or the Ethertype field, as alternative or additional packet match criteria.

TABLE 1

| | | | | | | Ethertype | | | |
|---|---|---|---|---|---|---|---|---|---|
| | | | | | | (Ethernet | | Frame | |
| | | Start | | | | II) or | | check | |
| | | frame | | | 802.1Q | length | | sequence | |
| | | delimiter | MAC | MAC | tag | (IEEE | | (32-bit | Interpacket |
| Layer | Preamble | (SFD) | destination | source | (optional) | 802.3) | Payload | CRC) | gap (IPG) |
| Length | 7 | 1 | 6 | 6 | (4) | 2 | 42- | 4 | 12 |
| (octets) | | | | | | | 1500^{(c)} | | |
| Layer 2 | (not part | | ←64-1522 octets→ | | | | | | (not part |
| Ethernet | of the | | | | | | | | of the |
| frame | frame) | | | | | | | | frame) |
| Layer 1 | ← 64-1522 octets→ | | | | | | | | ←12 |
| Ethernet | | | | | | | | | octets→ |
| packet | | | | | | | | | |
| & IPG | | | | | | | | | |

The MII packet processor engine may support various MII protocol variants to enable compatibility with different Ethernet network speeds and configurations. In some cases, the MII may include Gigabit MII (GMII) for 1 Gbps speeds. GMII provides a parallel interface between the MAC layer and the PHY layer for Gigabit Ethernet applications. In some cases, the MII may include Reduced Gigabit MII (RGMII) for 1 Gbps with fewer pins than GMII. RGMII reduces the number of interface pins by using double data rate signaling, which may simplify circuit board design and reduce component costs. In some cases, the MII may include Serial Gigabit MII (SGMII) as a serial version of MII. SGMII uses a serial interface rather than a parallel interface, which may further reduce pin count and simplify routing on circuit boards. In some cases, the MII may include Reduced MII (RMII) for 100 Mbps Ethernet. RMII provides a simplified interface with fewer pins for Fast Ethernet applications operating at 100 Mbps.

In some cases, the packet processing device may be adapted to support additional interface protocols beyond RGMII and SGMII. In some cases, the packet processing device may be modified to work with 10 Gigabit Media-Independent Interface (XGMII) for 10 Gigabit Ethernet networks. XGMII provides a 32-bit wide data path operating at 156.25 MHz to support 10 Gbps data rates. In some cases, the packet processing device may be adapted to support Quad Serial Gigabit Media-Independent Interface (QSGMII) for higher density applications. QSGMII combines four SGMII interfaces into a single serial interface, which may reduce pin count and enable higher port density in network equipment. The adaptability of the packet processing device to support various MII protocol variants may expand compatibility with a wider range of Ethernet systems while maintaining low-latency characteristics.

The packet processing device may be compatible with various Ethernet types and physical layer standards. In some cases, the packet processing device may work with 10Base-T Ethernet, which operates at 10 Mbps over twisted pair cabling. In some cases, the packet processing device may work with 100Base-TX Ethernet, which operates at 100 Mbps over Category 5 or higher twisted pair cabling. In some cases, the packet processing device may work with 1000Base-T Ethernet, which operates at 1 Gbps over Category 5e or higher twisted pair cabling. In some cases, the packet processing device may work with 100Base-T1 Ethernet, which operates at 100 Mbps over a single twisted pair for automotive applications. In some cases, the packet processing device may work with 1000Base-T1 Ethernet, which operates at 1 Gbps over a single twisted pair for automotive applications. In some cases, the packet processing device may work with 10GBase-T Ethernet, which operates at 10 Gbps over Category 6a, higher twisted pair cabling, or Fiber Optic links.

The packet processing device may support automotive Ethernet protocols and standards. In some cases, the packet processing device may be designed to work with car Ethernet such as 100Base-T1. The 100Base-T1 standard enables 100 Mbps Ethernet communication over a single unshielded twisted pair, which may reduce cabling weight and cost in automotive applications. In some cases, the packet processing device may support IEEE 802.3bw, which defines 100Base-T1 for automotive Ethernet. In some cases, the packet processing device may support IEEE 802.3 bp, which defines 1000Base-T1 for automotive Ethernet at 1 Gbps over a single twisted pair. In some cases, the packet processing device may support IEEE 802.3bq, which defines 25GBase-T and 40GBase-T for data center applications. In some cases, the packet processing device may support IEEE 802.3br, which defines interspersing express traffic for time-sensitive networking. In some cases, the packet processing device may support IEEE 802.3bs, which defines 200GBase and 400GBase Ethernet for high-speed data center applications. In some cases, the packet processing device may support IEEE 802.3bt, which defines Power over Ethernet (POE) enhancements. In some cases, the packet processing device may support IEEE 802.3bu, which defines Power over Data Lines (PoDL) for single-pair Ethernet. In some cases, the packet processing device may support IEEE 802.3bv, which defines Gigabit Ethernet over plastic optical fiber.

In some cases, the packet processing device may include a MATEnet interface for automotive applications. MATEnet is an automotive Ethernet connector system designed for 100Base-T1 and 1000Base-T1 applications in vehicles. The MATEnet interface may enable the packet processing device to connect directly to automotive Ethernet networks using standardized automotive connectors. The support for MATEnet and automotive Ethernet protocols may enable the packet processing device to perform network diagnostics and robustness testing in automotive environments where Ethernet networks are used for vehicle communication systems, advanced driver assistance systems, and infotainment systems.

In some cases, the packet processing device may support IEEE standards for Time Sensitive Networking (TSN). TSN is a set of IEEE 802.1 standards that define mechanisms for deterministic, low-latency communication over Ethernet networks. TSN standards may enable time-synchronized and reliable data transmission for applications where timing and reliability are desired, such as industrial automation, automotive systems, and professional audio/video applications.

In some cases, the packet processing device may support Precision Time Protocol (PTP) as defined in IEEE 1588. PTP provides a mechanism for synchronizing clocks throughout a network to sub-microsecond accuracy. The packet processing device may account for transit ingress time and transit egress time through each channel when supporting PTP. The transit ingress time refers to the time at which a packet enters a port of the packet processing device. The transit egress time refers to the time at which a packet exits a port of the packet processing device. By accounting for the transit ingress time and the transit egress time through each channel, the packet processing device may enable accurate timestamping of packets for PTP synchronization purposes.

In some cases, the packet processing device may support packet preemption as defined in IEEE 802.1Qbu and IEEE 802.3br. Packet preemption allows high priority packets to interrupt transmission of low priority packets. When a high priority packet arrives for transmission while a low priority packet is being transmitted, the packet processing device may suspend transmission of the low priority packet, transmit the high priority packet, and then resume transmission of the low priority packet. The packet preemption capability may reduce latency for high priority traffic in TSN networks by allowing time-sensitive packets to be transmitted without waiting for completion of lower priority packet transmissions.

In some cases, the packet processing device may include a hardware accelerator for accelerating packet processing operations with minimal delay. The hardware accelerator may perform packet inspection, packet manipulation, CRC calculation, and packet forwarding operations in hardware rather than software. Hardware acceleration may enable the packet processing device to achieve lower latency and higher throughput compared to software-based packet processing approaches.

In some cases, the hardware accelerator may comprise a field-programmable gate array (FPGA). An FPGA may be configured to implement custom logic for packet processing operations. The configurable nature of an FPGA may allow the packet processing device to be adapted for different packet processing requirements without requiring changes to physical hardware. In some cases, the hardware accelerator may comprise an application-specific integrated circuit (ASIC). An ASIC may be designed specifically for packet processing operations and may provide higher performance and lower power consumption compared to an FPGA for fixed packet processing functions.

In some cases, the packet processing device may include a processor for performing packet processing operations. The processor may be a microprocessor, a central processing unit (CPU), a graphics processing unit (GPU), a digital signal processor (DSP), an application-specific integrated circuit (ASIC), a field-programmable gate array (FPGA), or any combination of processing devices. In some cases, the processor may comprise a microprocessor that executes software instructions for packet processing operations. In some cases, the processor may comprise a CPU that provides general-purpose computing capabilities for packet processing and device management functions. In some cases, the processor may comprise a GPU that provides parallel processing capabilities for packet processing operations. In some cases, the processor may comprise a DSP that provides specialized signal processing capabilities for packet analysis and manipulation. In some cases, the processor may comprise an ASIC that provides dedicated hardware for specific packet processing functions. In some cases, the processor may comprise an FPGA that provides configurable hardware for packet processing operations. In some cases, the processor may comprise a combination of two or more of a microprocessor, a CPU, a GPU, a DSP, an ASIC, and an FPGA to provide a combination of processing capabilities for packet processing operations.

In some cases, the packet processing device may include a diagnostic module for diagnosing network issues. The diagnostic module may include various diagnostic tools for analyzing network behavior and identifying problems within the Ethernet network. In some cases, the diagnostic module may include network analyzers that examine network traffic patterns, protocol behavior, and communication flows between network devices. In some cases, the diagnostic module may include packet sniffers that capture and analyze individual Ethernet packets traversing the network. The packet sniffers may enable detailed examination of packet contents, headers, and payloads for troubleshooting purposes. In some cases, the diagnostic module may include network monitors that track network performance metrics, device status, and connectivity information over time.

In some cases, the diagnostic module may support various diagnostic protocols for communicating with other network devices and management systems. In some cases, the diagnostic module may support Internet Control Message Protocol (ICMP) for network diagnostic functions such as ping and traceroute operations. ICMP may enable the packet processing device to test connectivity to other network devices and measure round-trip times for packets. In some cases, the diagnostic module may support Simple Network Management Protocol (SNMP) for network management and monitoring functions. SNMP may enable the packet processing device to exchange management information with network management systems, respond to queries about device status, and send notifications about network events.

In some cases, the packet processing device may include a logging module for logging the operation of the device. The logging module may record events, packet information, and performance data for later analysis and troubleshooting. In some cases, the logging module may include event loggers that record device events such as configuration changes, error conditions, and operational state transitions. In some cases, the logging module may include packet loggers that record information about packets processed by the packet processing device, including packet headers, timestamps, and processing actions performed. In some cases, the logging module may include performance loggers that record performance metrics such as packet throughput, processing latency, and resource utilization over time.

In some cases, the logging module may support various logging protocols for transmitting log data to external systems. In some cases, the logging module may support Syslog protocol for transmitting log messages to centralized log servers. Syslog may enable the packet processing device to send log messages to remote servers for storage, analysis, and correlation with logs from other network devices. In some cases, the logging module may support SNMP for transmitting log data and event notifications to network management systems. SNMP traps and notifications may enable the packet processing device to alert network administrators about events and conditions that may require attention.

In some cases, the packet processing device may include a firmware update module for updating the firmware of the device. The firmware update module may enable network administrators or technicians to update the firmware of the packet processing device to add features, fix bugs, or improve performance. In some cases, the firmware update module may include firmware downloaders that retrieve firmware images from remote servers. In some cases, the firmware update module may include firmware installers that apply firmware updates to the packet processing device. In some cases, the firmware update module may include firmware updaters that manage the firmware update process including verification of firmware integrity and rollback capabilities.

In some cases, the firmware update module may support various firmware update protocols for retrieving firmware images from remote servers. In some cases, the firmware update module may support Trivial File Transfer Protocol (TFTP) for retrieving firmware images. TFTP may provide a simple mechanism for transferring firmware files without requiring authentication or complex session management. In some cases, the firmware update module may support File Transfer Protocol (FTP) for retrieving firmware images. FTP may provide file transfer capabilities with authentication and directory navigation features. In some cases, the firmware update module may support Hypertext Transfer Protocol (HTTP) for retrieving firmware images. HTTP may enable firmware downloads from web servers and may support secure transfers using HTTPS.

In some cases, the packet processing device may include a self-test module for performing self-tests on the device. The self-test module may enable the packet processing device to verify proper operation of hardware components and detect faults that may affect device functionality. In some cases, the self-test module may include power-on self-test (POST) tools that execute when the packet processing device is powered on. POST tools may verify proper operation of memory, processors, and other hardware components during device initialization. In some cases, the self-test module may include built-in self-test (BIST) tools that perform comprehensive testing of hardware components. BIST tools may test logic circuits, memory arrays, and communication interfaces to detect manufacturing defects or component failures. In some cases, the self-test module may include online self-test tools that perform testing while the packet processing device is operating. Online self-test tools may detect intermittent faults or degradation of hardware components without requiring the device to be taken offline.

In some cases, the packet processing device may include a fault detection and isolation module for detecting and isolating faults in the device. The fault detection and isolation module may identify hardware or software faults and determine the location or cause of the fault to facilitate repair or recovery. In some cases, the fault detection and isolation module may include fault detectors that monitor device operation and identify conditions that indicate a fault has occurred. Fault detectors may monitor error rates, timing violations, and other indicators of abnormal operation. In some cases, the fault detection and isolation module may include fault isolators that determine the specific component or subsystem where a fault has occurred. Fault isolators may use diagnostic tests and analysis techniques to narrow down the location of a fault. In some cases, the fault detection and isolation module may include fault analyzers that analyze fault data to determine the root cause of a fault and recommend corrective actions.

In some cases, the packet processing device may include a performance monitoring module for monitoring the performance of the device. The performance monitoring module may track performance metrics and provide visibility into device operation for capacity planning and optimization purposes. In some cases, the performance monitoring module may include performance counters that track metrics such as packet counts, byte counts, error counts, and processing times. Performance counters may provide quantitative data about device operation that can be used for performance analysis. In some cases, the performance monitoring module may include performance analyzers that process performance data to identify trends, anomalies, and optimization opportunities.

In some cases, the performance monitoring module may support various performance monitoring protocols for reporting performance data to external systems. In some cases, the performance monitoring module may support SNMP for reporting performance metrics to network management systems. SNMP may enable the packet processing device to respond to queries about performance counters and send notifications when performance thresholds are exceeded. In some cases, the performance monitoring module may support NetFlow protocol for reporting traffic flow information. NetFlow may enable the packet processing device to export information about network traffic flows including source and destination addresses, port numbers, protocol types, and byte counts. The traffic flow information exported via NetFlow may be collected and analyzed by flow collectors for network traffic analysis, capacity planning, and security monitoring purposes.

In some cases, the packet processing device may include a packet filtering module for filtering packets handled by the device. The packet filtering module may enable the packet processing device to selectively process, forward, or drop packets based on defined criteria. In some cases, the packet filtering module may include packet filters that examine packet headers and payloads to determine whether packets match specified filtering rules. Packet filters may compare packet attributes such as source addresses, destination addresses, port numbers, and protocol types against filtering criteria to make forwarding decisions. In some cases, the packet filtering module may include packet classifiers that categorize packets into different classes based on packet attributes. Packet classifiers may assign packets to traffic classes for differentiated handling based on quality of service requirements or traffic management policies. In some cases, the packet filtering module may include packet markers that add or modify markings in packet headers to indicate traffic class or priority. Packet markers may set differentiated services code point (DSCP) values, 802.1p priority bits, or other header fields to enable downstream network devices to provide appropriate handling for marked packets. In some cases, the packet filtering module may include packet policers that enforce traffic rate limits and traffic profiles. Packet policers may measure traffic rates and take actions such as dropping, remarking, or delaying packets that exceed configured rate limits.

In some cases, the packet filtering module may support various packet filtering protocols for defining and applying filtering rules. In some cases, the packet filtering module may support Access Control List (ACL) protocols for defining packet filtering rules. ACLs may specify permit or deny actions for packets matching defined criteria based on source addresses, destination addresses, port numbers, protocol types, and other packet attributes. ACLs may be applied to incoming or outgoing traffic on specific ports of the packet processing device to control which packets are forwarded or dropped. In some cases, the packet filtering module may support Policy-Based Routing (PBR) protocols for routing packets based on policies rather than destination addresses alone. PBR may enable the packet processing device to route packets based on source addresses, application types, packet sizes, or other criteria defined in routing policies. PBR may enable more flexible traffic engineering and load balancing compared to traditional destination-based routing.

In some cases, the packet processing device may include a packet routing module for routing packets handled by the device. The packet routing module may enable the packet processing device to forward packets toward their destinations based on routing information. In some cases, the packet routing module may include packet routers that make forwarding decisions based on destination addresses and routing tables. Packet routers may examine destination addresses in packet headers and consult routing tables to determine the appropriate output port or next hop for each packet. In some cases, the packet routing module may include packet switches that forward packets based on layer 2 addresses. Packet switches may examine MAC addresses in Ethernet frame headers and consult forwarding tables to determine the appropriate output port for each frame. In some cases, the packet routing module may include packet gateways that provide connectivity between different network segments or protocol domains. Packet gateways may perform protocol translation, address translation, or other functions to enable communication between networks with different characteristics. In some cases, the packet routing module may include packet bridges that connect network segments at the data link layer. Packet bridges may forward frames between network segments based on MAC addresses while filtering traffic that does not need to cross segment boundaries.

In some cases, the packet routing module may support various routing protocols for exchanging routing information with other network devices. In some cases, the packet routing module may support Routing Information Protocol (RIP) for exchanging routing information. RIP is a distance-vector routing protocol that uses hop count as a routing metric. RIP may enable the packet processing device to exchange routing information with neighboring routers and build routing tables for forwarding packets. In some cases, the packet routing module may support Open Shortest Path First (OSPF) protocol for exchanging routing information. OSPF is a link-state routing protocol that uses link costs as routing metrics and builds a complete topology map of the network. OSPF may enable the packet processing device to compute shortest paths to destinations and adapt to network topology changes. In some cases, the packet routing module may support Border Gateway Protocol (BGP) for exchanging routing information between autonomous systems. BGP is a path-vector routing protocol used for inter-domain routing on the Internet. BGP may enable the packet processing device to exchange routing information with routers in other autonomous systems and make routing decisions based on path attributes and routing policies.

In some cases, the packet processing device may include a packet switching module for switching packets handled by the device. The packet switching module may enable the packet processing device to forward Ethernet frames based on MAC addresses and maintain loop-free network topologies. In some cases, the packet switching module may support Spanning Tree Protocol (STP) for preventing loops in bridged networks. STP may enable the packet processing device to participate in spanning tree calculations with other bridges and switches to establish a loop-free topology by blocking redundant paths. STP may detect topology changes and recalculate the spanning tree to maintain connectivity while preventing loops. In some cases, the packet switching module may support Rapid Spanning Tree Protocol (RSTP) for faster convergence than STP. RSTP may enable the packet processing device to converge more quickly after topology changes by using different port states and roles compared to STP. RSTP may reduce network downtime during topology changes compared to STP. In some cases, the packet switching module may support Multiple Spanning Tree Protocol (MSTP) for supporting multiple spanning tree instances. MSTP may enable the packet processing device to map different VLANs to different spanning tree instances, allowing traffic from different VLANs to take different paths through the network. MSTP may enable more efficient use of redundant links compared to a single spanning tree instance.

In some cases, the packet processing device may include a packet gateway module for providing gateway services to packets handled by the device. The packet gateway module may enable the packet processing device to perform address translation and other gateway functions for packets traversing between different network segments. In some cases, the packet gateway module may support Network Address Translation (NAT) for translating network addresses in packet headers. NAT may enable the packet processing device to translate source or destination IP addresses in packets as they traverse between network segments with different address spaces. NAT may enable devices with private IP addresses to communicate with devices on public networks by translating private addresses to public addresses. In some cases, the packet gateway module may support Port Address Translation (PAT) for translating port numbers in addition to network addresses. PAT may enable the packet processing device to translate source or destination port numbers in packets to allow multiple devices to share a single public IP address. PAT may map different internal source addresses and port numbers to different port numbers on a single external address, enabling many-to-one address translation.

In some cases, the packet processing device may include a packet analyzer module for analyzing packets handled by the device. The packet analyzer module may enable the packet processing device to examine packet contents and provide detailed information about network traffic for troubleshooting and analysis purposes. In some cases, the packet analyzer module may support Wireshark protocol for packet analysis. Wireshark is a network protocol analyzer that can capture and analyze network traffic. The packet analyzer module may capture packets and provide analysis capabilities compatible with Wireshark, enabling users to examine packet contents, decode protocol headers, and analyze communication flows. In some cases, the packet analyzer module may support tcpdump protocol for packet capture and analysis. tcpdump is a command-line packet analyzer that can capture and display network traffic. The packet analyzer module may capture packets and provide output compatible with tcpdump, enabling users to filter and examine packets using tcpdump syntax and tools.

In some cases, the packet processing device may include a packet generator module for generating packets for testing purposes. The packet generator module may enable the packet processing device to create and transmit test packets for network testing, performance measurement, and troubleshooting. In some cases, the packet generator module may include packet generators that create packets with specified contents and attributes. Packet generators may create packets with defined source addresses, destination addresses, payload contents, and other attributes for testing network behavior under controlled conditions. In some cases, the packet generator module may include packet injectors that insert packets into network traffic streams. Packet injectors may transmit generated packets onto the network to test how network devices and applications respond to specific packet types or traffic patterns. In some cases, the packet generator module may include packet emulators that simulate traffic from network devices or applications. Packet emulators may generate traffic patterns that mimic real network devices or applications for testing network capacity, performance, and behavior under realistic traffic conditions.

In some cases, the packet generator module may support various packet generation protocols and tools. In some cases, the packet generator module may support Scapy for packet generation and manipulation. Scapy is a packet manipulation tool that can create, send, capture, and analyze network packets. The packet generator module may generate packets using Scapy-compatible syntax and capabilities, enabling users to create custom packets with arbitrary protocol headers and payloads. In some cases, the packet generator module may support hping for packet generation and network testing. hping is a command-line packet generator and analyzer that can send custom packets and analyze responses. The packet generator module may generate packets using hping-compatible capabilities, enabling users to perform network testing, firewall testing, and security auditing.

In some cases, the packet processing device may include a packet capturer module for capturing packets for analysis purposes. The packet capturer module may enable the packet processing device to capture and store packets traversing the device for later analysis and troubleshooting. In some cases, the packet capturer module may capture packets based on filtering criteria to selectively capture packets of interest. The filtering criteria may include source addresses, destination addresses, port numbers, protocol types, and other packet attributes. In some cases, the packet capturer module may store captured packets in memory or non-volatile storage for later retrieval and analysis. In some cases, the packet capturer module may export captured packets in standard formats compatible with packet analysis tools such as Wireshark and tcpdump. The packet capturer module may enable network administrators or technicians to capture packets for analyzing network behavior, diagnosing network issues, and verifying proper operation of network devices and applications.

In some cases, the packet processing device may include a packet sniffer module for sniffing packets handled by the device. The packet sniffer module may include various packet sniffer tools, such as packet sniffers, packet analyzers, packet monitors, or other types of packet sniffer tools. The packet sniffer module may support various packet sniffer protocols, such as Wireshark, tcpdump, or other types of packet sniffer protocols. The packet sniffer module may enable network administrators or technicians to sniff packets handled by the device and diagnose network issues.

In some cases, the packet processing device may include a packet monitor module for monitoring packets handled by the device. The packet monitor module may include various packet monitor tools, such as packet monitors, packet analyzers, packet sniffers, or other types of packet monitor tools. The packet monitor module may support various packet monitor protocols, such as Wireshark, tcpdump, or other types of packet monitor protocols. The packet monitor module may enable network administrators or technicians to monitor packets handled by the device and diagnose network issues.

In some cases, the packet processing device may include a packet tracer module for tracing packets handled by the device. The packet tracer module may include various packet tracer tools, such as packet tracers, packet analyzers, packet sniffers, or other types of packet tracer tools. The packet tracer module may support various packet tracer protocols, such as Wireshark, tcpdump, or other types of packet tracer protocols. The packet tracer module may enable network administrators or technicians to trace packets handled by the device and diagnose network issues.

In some cases, the packet processing device may include a packet emulator module for emulating packets for testing purposes. The packet emulator module may include various packet emulator tools, such as packet emulators, packet generators, packet injectors, or other types of packet emulator tools. The packet emulator module may support various packet emulator protocols, such as Scapy, hping, or other types of packet emulator protocols. The packet emulator module may enable network administrators or technicians to emulate packets for testing the network and diagnosing network issues.

In some cases, the packet processing device may include a packet injector module for injecting packets into the network for testing purposes. The packet injector module may include various packet injector tools, such as packet injectors, packet generators, packet emulators, or other types of packet injector tools. The packet injector module may support various packet injector protocols, such as Scapy, hping, or other types of packet injector protocols. The packet injector module may enable network administrators or technicians to inject packets into the network for testing the network and diagnosing network issues.

In some cases, the packet processing device may include a packet logger module for logging packets for analysis purposes. The packet logger module may include various packet logger tools, such as packet loggers, packet analyzers, or other types of packet logger tools. The packet logger module may enable network administrators or technicians to log packets for analyzing the network and diagnosing network issues.

In some cases, the packet processing device may include a packet bridging module for bridging packets handled by the device. The packet bridging module may include various packet bridging tools, such as packet bridges, packet switches, packet routers, packet gateways, or other types of packet bridging tools. The packet bridging module may support various packet bridging protocols, such as Spanning Tree Protocol (STP), Rapid Spanning Tree Protocol (RSTP), Multiple Spanning Tree Protocol (MSTP), or other types of packet bridging protocols. The packet bridging module may enable network administrators or technicians to bridge packets handled by the device and optimize network performance.

In some cases, the packet processing device may include a user interface for configuring the device and monitoring its operation. The user interface may provide real-time visualization of packet flows and statistics, enhancing the diagnostic capabilities of the device. The user interface may enable users to manually adjust the configuration tables, activate or deactivate the independent timers, and perform other operations on the device. In some cases, the user interface may be implemented as a graphical user interface displayed on the display screen of the device. In some cases, the user interface may be implemented as a web-based interface accessible from a remote location.

In some cases, the packet processing device may be utilized in avionics and aerospace applications to analyze network performance and robustness during normal and abnormal conditions. Avionics systems in aircraft may use Ethernet networks for communication between various avionics components, including flight control systems, navigation systems, communication systems, and display systems. The packet processing device may be inserted between avionics components to monitor and manipulate Ethernet traffic for testing and diagnostic purposes. In some cases, the packet processing device may be used to test compliance with ARINC 664 Part 7 specifications, which define the Avionics Full-Duplex Switched Ethernet (AFDX) network for aircraft data networks. The packet processing device may inspect Virtual Link (VL) identifiers in packet headers to identify and manipulate specific traffic flows between avionics systems. In some cases, the packet processing device may simulate network anomalies such as packet loss, packet delay, or packet corruption to test how avionics systems respond to degraded network conditions. The ability to simulate abnormal conditions may enable avionics engineers to verify that avionics systems maintain safe operation when network faults occur. In some cases, the packet processing device may measure transit delays and jitter for packets traversing avionics networks to verify that timing requirements are met for time-sensitive avionics applications.

In some cases, the packet processing device may be utilized in automotive applications to test and diagnose Ethernet connections in vehicles. Modern vehicles may use Ethernet networks for communication between various vehicle systems, including in-vehicle infotainment systems, advanced driver-assistance systems (ADAS), and vehicle-to-everything (V2X) communication systems. In-vehicle infotainment systems may use Ethernet networks to stream audio and video content, provide navigation services, and connect to external devices and networks. The packet processing device may be used to test the performance and reliability of Ethernet connections supporting infotainment functions. Advanced driver-assistance systems may use Ethernet networks to transmit sensor data from cameras, radar, and lidar sensors to processing units that perform object detection, lane keeping, and collision avoidance functions. The packet processing device may be used to test ADAS network performance under various conditions, including simulated sensor failures or network congestion. Vehicle-to-everything communication systems may use Ethernet networks as part of the communication infrastructure for exchanging information with other vehicles, roadside infrastructure, and cloud services. The packet processing device may be used to test V2X communication reliability and latency to verify that safety-related messages are delivered within required time constraints. In some cases, the packet processing device may support automotive Ethernet standards such as 100Base-T1 and 1000Base-T1, which use single twisted pair cabling designed for automotive environments.

In some cases, the packet processing device may be utilized in industrial networks to analyze network performance and robustness in industrial automation and control systems. Industrial facilities such as manufacturing plants, power plants, and other industrial facilities may use Ethernet networks for communication between programmable logic controllers, sensors, actuators, human-machine interfaces, and supervisory control systems. The packet processing device may be inserted into industrial Ethernet networks to monitor and manipulate traffic for testing and diagnostic purposes. In some cases, the packet processing device may be used to test network performance under various load conditions to verify that industrial control systems maintain required response times. In some cases, the packet processing device may simulate network faults such as packet loss or packet delay to test how industrial control systems respond to degraded network conditions. The ability to simulate abnormal conditions may enable industrial engineers to verify that safety systems and fail-safe mechanisms operate correctly when network faults occur. In some cases, the packet processing device may measure timing characteristics of industrial Ethernet traffic to verify compliance with real-time communication requirements for industrial automation applications.

In some cases, the packet processing device may be used for cybersecurity testing by modifying packets on the fly to identify vulnerabilities in network devices and applications. The packet processing device may intercept Ethernet traffic and modify packet contents in real-time to test how network devices and applications respond to malformed or malicious packets. In some cases, the packet processing device may modify packet headers to test how network devices handle packets with invalid or unexpected header values. In some cases, the packet processing device may modify packet payloads to test how applications handle malformed or malicious data. In some cases, the packet processing device may inject packets with spoofed source addresses to test whether network devices properly validate packet origins. In some cases, the packet processing device may corrupt CRC values to test whether network devices properly detect and handle packets with transmission errors. The ability to modify packets on the fly may enable security researchers and network administrators to identify vulnerabilities in network devices and applications before malicious actors can exploit such vulnerabilities. In some cases, the packet processing device may be used to test intrusion detection systems and firewalls by generating traffic patterns that simulate attack scenarios. The cybersecurity testing capabilities of the packet processing device may enable organizations to improve the security posture of their Ethernet networks by identifying and addressing vulnerabilities in network infrastructure and connected devices.

The packet processing device functions as an integrated system for real-time Ethernet packet processing at the media independent interface level, enabling packet inspection, manipulation, forwarding, and sniffing with minimal delay for network diagnostics and robustness testing. The packet processing device operates at the MII layer rather than at higher layers of the OSI model, which enables the packet processing device to process Ethernet packets with delays that are substantially less than delays introduced by conventional approaches. In some cases, the packet processing device may introduce delays of less than 7 microseconds at 100Base-T Ethernet protocols and less than 2 microseconds at 1000Base-T Ethernet protocols. The minimal delay characteristics of the packet processing device enable the packet processing device to be inserted between any Ethernet link for system level diagnostic and robustness testing without requiring reconfiguration of the network to account for processing delays.

The packet processing device provides adaptability across a range of use cases and network environments. In some cases, the packet processing device may be utilized in avionics and aerospace applications where Ethernet networks are used for communication between avionics components such as flight control systems, navigation systems, communication systems, and display systems. In some cases, the packet processing device may be utilized in automotive applications where Ethernet networks are used for communication between vehicle systems such as in-vehicle infotainment systems, advanced driver-assistance systems, and vehicle-to-everything communication systems. In some cases, the packet processing device may be utilized in industrial networks where Ethernet networks are used for communication between programmable logic controllers, sensors, actuators, human-machine interfaces, and supervisory control systems. The packet processing device may support various Ethernet physical layer standards including 10Base-T, 100Base-T, 100Base-TX, 1000Base-T, 100Base-T1, and 1000Base-T1, enabling compatibility with Ethernet networks deployed in diverse environments.

The configuration tables of the packet processing device provide flexibility for adapting the packet processing device to different testing and diagnostic requirements. Each configuration table stores packet match criteria and corresponding packet manipulations that define how incoming packets are processed. The packet match criteria may be based on a subset of bits of a MAC destination address, such as the first 12 bits corresponding to a Virtual Link identifier as defined in the ARINC 664 Part 7 specification, or other features in an Ethernet frame or packet format as defined by IEEE 802.3. The configuration tables may be set up to operate in sequential mode or concurrent mode. In sequential mode, a table index is incremented to a next entry in the configuration table after performing a packet manipulation, which may be useful for detecting events that occur in a specific order. In concurrent mode, table entry match criteria directly index into the configuration table, allowing the packet processing device to process multiple packets simultaneously and handle high-volume network traffic.

The packet manipulations supported by the packet processing device include packet content modification with CRC update, packet termination, CRC corruption, and introducing specified packet delays. Packet termination may occur by not forwarding a selected packet, interrupting a packet in mid-stream, or selectively intermittently dropping packets to simulate abnormal or failure conditions. The ability to perform various packet manipulations enables the packet processing device to test the robustness and performance of networks under various conditions, including simulated network errors, failures, and congestion scenarios.

The packet processing device provides timing measurement capabilities through a plurality of independent timers that may be activated based on instructions in the configuration tables. Each configuration table entry may turn on or off one or more of the independent timers to measure timing between any two incoming packets. The timing measurements may be used to measure transit delay and jitter within a network, measure timing between two different packets on a network, or measure equipment response time between receiving one packet and transmitting another packet. In some cases, the timing information may be represented in 32 bits with an 8 nanosecond resolution and may be transmitted to a host computer for further analysis or depicted as an electrical pulse whose width is the actual delay in time.

The packet processing device provides traffic sniffing capabilities that enable monitoring of network traffic by other equipment. In some cases, the packet processing device may replicate or route traffic from one port pair to another port pair to support seamless monitoring. The sniffing functionality may be performed selectively on selected packets as defined in the configuration tables. In some cases, sniffed packets may be timestamped for time of arrival using an internal oscillator. A free running timestamp may be inserted at a user-defined location in the routed or sniffed packet payload. In some cases, the internal oscillator may be synchronized to a particular received packet periodically, which may be useful for diagnostic and robustness testing of synchronous Ethernet networks.

The four-port configuration of the packet processing device enables simultaneous operation on two separate Ethernet links for complex network testing scenarios. The four-port configuration comprises two port pairs, with each port pair capable of bidirectional packet processing according to its own configuration tables. In some cases, the four-port configuration may enable timing measurement between two segments in a network where one port pair is inserted in one segment and another port pair is inserted in another segment. In some cases, the four-port configuration may be used to test networks involving one or more switches to measure transit delays on specific packets across multiple network segments. The four-port configuration may also enable the packet processing device to replicate traffic from one port pair to another port pair for sniffing purposes while maintaining the original traffic flow through the first port pair. The combination of multiple port pairs, configuration tables, packet manipulation capabilities, timing measurements, and traffic sniffing capabilities enables the packet processing device to address a wide range of network testing and diagnostic requirements in avionics, automotive, industrial, and other network environments.

The following clauses illustrate various aspects and embodiments of the present disclosure.

Clause 1: A device for processing a network packet, the device comprising: a first port configured to receive and transmit network packets; a second port configured to receive and transmit network packets; a media independent interface coupled to the first port and the second port; a configuration table storing one or more packet match criteria and one or more corresponding packet manipulations; and a programmable logic device coupled to the media independent interface and the configuration table, wherein the programmable logic device is configured to: inspect a subset of bits of a media access control destination address of a network packet at the media independent interface; compare the inspected bits against the one or more packet match criteria in the configuration table to determine whether the network packet is a matched packet when a match is found or an unmatched packet when no match is found; perform a packet manipulation on a matched packet according to the one or more corresponding packet manipulations in the configuration table to produce a manipulated packet; and forward a manipulated packet or an unmatched packet to the first port or the second port with minimal delay.

Clause 2: The device of Clause 1, wherein the one or more corresponding packet manipulations include at least one of: packet content modification with cyclic redundancy check update, packet termination, cyclic redundancy check corruption, or introducing a specified packet delay.

Clause 3: The device of Clause 1 or Clause 2, further comprising: a third port configured to receive and transmit network packets; a fourth port configured to receive and transmit network packets; and a second configuration table storing one or more packet match criteria and one or more corresponding packet manipulations; wherein the programmable logic device is further configured to: receive a network packet at the third port; process the network packet received at the third port according to the second configuration table; and forward the processed network packet to the fourth port.

Clause 4: The device of any of Clauses 1-3, wherein the programmable logic device is further configured to operate in a sequential mode or a concurrent mode based on the configuration table.

Clause 5: The device of any of Clauses 1-4, wherein in the sequential mode, the programmable logic device increments to a next entry in the configuration table after performing a packet manipulation.

Clause 6: The device of any of Clauses 1-5, wherein in the concurrent mode, the programmable logic device directly indexes into the configuration table based on the one or more packet match criteria.

Clause 7: The device of any of Clauses 1-6, further comprising a plurality of independent timers, wherein the programmable logic device is configured to activate one or more of the plurality of independent timers to measure timing between network packets based on instructions in the configuration table.

Clause 8: The device of any of Clauses 1-7, wherein the subset of bits of the media access control destination address comprises 12 bits first listed in the media access control destination address.

Clause 9: The device of any of Clauses 1-8, wherein the minimal delay is less than 6 microseconds in a network operating at a network speed of 100 megabits per second.

Clause 10: The device of any of Clauses 1-9, wherein the programmable logic device comprises a field-programmable gate array.

Clause 11: The device of any of Clauses 3-10, further comprising a timestamp system configured to add a timestamp to a payload of one or more selected network packets received at or transmitted out of the third port or the fourth port.

Clause 12: The device of any of Clauses 1-11, further comprising one or more timers and a timestamp system, wherein either the one or more timers or the timestamp system synchronizes time to a network packet.

Clause 13: A method for processing a network packet, the method comprising: receiving a network packet at a first port of a diagnostic device; inspecting, at a media independent interface layer, a subset of bits of a media access control destination address of the network packet; comparing the inspected bits against one or more packet match criteria stored in a configuration table to determine whether the network packet is a matched packet when a match is found or an unmatched packet when no match is found; if the network packet is a matched packet, performing a packet manipulation on the matched packet to produce a manipulated packet, wherein the packet manipulation is specified in the configuration table; and forwarding the manipulated packet or an unmatched packet to a second port of the diagnostic device with a delay of less than 6 microseconds.

Clause 14: The method of Clause 13, wherein the packet manipulation includes at least one of: packet content modification with cyclic redundancy check update, packet termination, cyclic redundancy check corruption, or introducing a specified packet delay.

Clause 15: The method of Clause 13 or Clause 14, further comprising: receiving a plurality of network packets at the first port; and activating one or more independent timers to measure timing between each of the plurality of network packets received at the first port.

Clause 16: The method of any of Clauses 13-15, further comprising operating in a sequential mode or a concurrent mode based on the configuration table.

Clause 17: The method of Clause 16, wherein the sequential mode comprises incrementing to a next entry in the configuration table after performing a packet manipulation.

Clause 18: The method of Clause 16 or Clause 17, wherein the concurrent mode comprises directly indexing into the configuration table based on the one or more packet match criteria.

Clause 19: The method of any of Clauses 13-18, further comprising: receiving a plurality of network packets at a third port and a fourth port of the diagnostic device; and adding a timestamp to a payload of one or more selected network packets of the plurality of network packets received at or transmitted out of the third port or the fourth port.

Clause 20: The method of any of Clauses 13-19, further comprising: receiving a plurality of network packets at the diagnostic device, the plurality of network packets comprising at least a first network packet and a second network packet; receiving the first network packet at the first port and transmitting the first network packet out of the second port; receiving the second network packet at a third port and transmitting the second network packet out of a fourth port; entirely copying content of the first network packet to produce an entirely copied first network packet or selectively copying content of the first network packet to produce a selectively copied first network packet; entirely copying content of the second network packet to produce an entirely copied second network packet or selectively copying content of the second network packet to produce a selectively copied second network packet; receiving the entirely copied first network packet or selectively copied first network packet at the third port and transmitting the entirely copied first network packet or selectively copied first network packet out of the fourth port; and receiving the entirely copied second network packet or selectively copied second network packet at the fourth port and transmitting the entirely copied second network packet or selectively copied second network packet out of the third port.

Clause 21: The method of any of Clauses 13-20, further comprising selectively dropping packets intermittently to simulate abnormal network conditions based on instructions in the configuration table.

Clause 22: A non-transitory computer-readable medium storing configuration data that, when used to configure a programmable logic device, causes the programmable logic device to perform operations for processing a network packet, the operations comprising: receiving a network packet at a media independent interface layer; inspecting a subset of bits of a media access control destination address of the network packet; comparing the inspected bits against one or more packet match criteria stored in a configuration table to determine whether the network packet is a matched packet if a match is found in the configuration table or an unmatched packet if no match is found in the configuration table; if the network packet is a matched packet, performing a packet manipulation on the matched packet to produce a manipulated packet, wherein the packet manipulation is specified in the configuration table; and forwarding the manipulated packet or an unmatched packet with a delay of less than 6 microseconds.

Clause 23: The non-transitory computer-readable medium of Clause 22, wherein the packet manipulation includes at least one of: packet content modification with cyclic redundancy check update, packet termination, cyclic redundancy check corruption, or introducing a specified packet delay.

Clause 24: The non-transitory computer-readable medium of Clause 22 or Clause 23, wherein the operations further comprise: receiving a plurality of network packets at the media independent interface; and activating one or more independent timers to measure timing between each of the plurality of network packets based on instructions in the configuration table.

Clause 25: The non-transitory computer-readable medium of any of Clauses 22-24, wherein the operations further comprise operating in a sequential mode or a concurrent mode based on the configuration table.

Clause 26: The non-transitory computer-readable medium of Clause 25, wherein the sequential mode comprises incrementing to a next entry in the configuration table after performing a packet manipulation.

Clause 27: The non-transitory computer-readable medium of Clause 25 or Clause 26, wherein the concurrent mode comprises directly indexing into the configuration table based on the one or more packet match criteria.

Clause 28: The non-transitory computer-readable medium of any of Clauses 22-27, wherein the operations further comprise adding a timestamp to a payload of a network packet.

Clause 29: The non-transitory computer-readable medium of any of Clauses 22-28, wherein the operations further comprise: receiving a plurality of network packets at a diagnostic device, the plurality of network packets comprising at least a first network packet and a second network packet; receiving the first network packet at a first port and transmitting the first network packet out of a second port; receiving the second network packet at the second port and transmitting the second network packet out of the first port; entirely copying content of the first network packet to produce an entirely copied first network packet or selectively copying content of the first network packet to produce a selectively copied first network packet; entirely copying content of the second network packet to produce an entirely copied second network packet or selectively copying content of the second network packet to produce a selectively copied second network packet; receiving the entirely copied first network packet or selectively copied first network packet at a third port and transmitting the entirely copied first network packet or selectively copied first network packet out of a fourth port; and receiving the entirely copied second network packet or selectively copied second network packet at the fourth port and transmitting the entirely copied second network packet or selectively copied second network packet out of the third port.

Clause 30: The non-transitory computer-readable medium of any of Clauses 22-29, wherein the subset of bits of the media access control destination address comprises 12 bits first listed in the media access control destination address.

Clause 31: A device for processing an Ethernet packet, comprising:
a first full duplex port and a second full duplex port, each port configured to receive and transmit an Ethernet packet, the Ethernet packet including a media access control (MAC) destination address comprising bits that uniquely identifies an intended recipient within a network;
a media independent interface (MII) coupled to the first full duplex port and the second full duplex port;
memory including a first configuration table and a second configuration table, each configuration table storing one or more packet match criteria and one or more corresponding packet manipulations;
   wherein a first Ethernet packet received at the first full duplex port is processed according to the first configuration table and transmitted out of the second full duplex port, and
   wherein a second Ethernet packet received at the second full duplex port is processed according to the second configuration table and transmitted out of the first full duplex port; and a field-programmable gate array (FPGA) coupled to the MII, the first configuration table, and the second configuration table, the FPGA configured to:
inspect a subset of bits of a MAC destination address of a third Ethernet packet at the MII;
   compare the inspected subset of bits against the one or more packet match criteria in the first configuration table or the second configuration table to determine whether a fourth Ethernet packet is a matched packet when a match is found or an unmatched packet when no match is found,
   perform a packet manipulation on a matched packet according to the one or more corresponding packet manipulations in the first configuration table or the second configuration table to produce a manipulated packet, and
   forward the manipulated packet or the unmatched packet to the first full duplex port or the second full duplex port with minimal delay of less than 6 microseconds in a network operating at a network speed of 100 megabits per second.

Clause 32. A method for processing an Ethernet packet, comprising:
receiving an Ethernet packet at a first full duplex port of a diagnostic device;
inspecting, at a media independent interface (MII) layer, a subset of bits of a MAC destination address of the Ethernet packet;
comparing the inspected subset of bits against one or more packet match criteria stored in at least one configuration table to determine whether the Ethernet packet is a matched packet when a match is found or an unmatched packet when no match is found;
if the Ethernet packet is a matched packet, performing a packet manipulation on the matched packet to produce a manipulated packet, wherein the packet manipulation is specified in the at least one configuration table; and
forwarding the manipulated packet or an unmatched packet to a second full duplex port of the diagnostic device.

While the disclosure has been described in connection with what is presently considered to be the most practical and preferred embodiments, it is to be understood that the disclosure is not to be limited to the disclosed embodiments, but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore, it should be understood that while the use of the word preferable, preferably, or preferred in the description above indicates that feature so described may be more desirable, it nonetheless may not be necessary and any embodiment lacking the same may be contemplated as within the scope of the disclosure, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary. Ordinal terms such as “first,” “second,” “third,” and “fourth” may refer to the same or different elements.

1. A device for processing an Ethernet packet, comprising:
a first full duplex port and a second full duplex port, each port configured to receive and transmit an Ethernet packet, the Ethernet packet including a media access control (MAC) destination address comprising bits that uniquely identifies an intended recipient within a network;
a media independent interface (MII) coupled to the first full duplex port and the second full duplex port;
memory including a first configuration table and a second configuration table, each configuration table storing one or more packet match criteria and one or more corresponding packet manipulations;
wherein a first Ethernet packet received at the first full duplex port is processed according to the first configuration table and transmitted out of the second full duplex port, and
wherein a second Ethernet packet received at the second full duplex port is processed according to the second configuration table and transmitted out of the first full duplex port; and
a field-programmable gate array (FPGA) coupled to the MII, the first configuration table, and the second configuration table, the FPGA configured to:
inspect a subset of bits of a MAC destination address of a third Ethernet packet at the MII;
compare the inspected subset of bits against the one or more packet match criteria in the first configuration table or the second configuration table to determine whether a fourth Ethernet packet is a matched packet when a match is found or an unmatched packet when no match is found,
perform a packet manipulation on a matched packet according to the one or more corresponding packet manipulations in the first configuration table or the second configuration table to produce a manipulated packet, and
forward the manipulated packet or the unmatched packet to the first full duplex port or the second full duplex port.

2. The device of claim 1, wherein the packet manipulation comprises at least one of: packet content modification with cyclic redundancy check (CRC) update, packet termination, CRC corruption, or introducing a specified packet delay.

3. The device of claim 1, further comprising:
a third full duplex port and a fourth full duplex port, each port configured to receive and transmit the Ethernet packet;
wherein the memory further includes a third configuration table and a fourth configuration table, each configuration table storing the one or more packet match criteria and the one or more corresponding packet manipulations;
wherein a fifth Ethernet packet received at the third full duplex port is processed according to the third configuration table and transmitted out of the fourth full duplex port; and
wherein a sixth Ethernet packet received at the fourth full duplex port is processed according to the fourth configuration table and transmitted out of the third full duplex port;
wherein the FPGA is coupled to the third configuration table and the fourth configuration table, the FPGA further configured to:
inspect a second subset of bits of a MAC destination address of a seventh Ethernet packet at the MII;
compare the inspected second subset of bits against the one or more packet match criteria in the third configuration table or the fourth configuration table to determine whether an eighth Ethernet packet is a matched packet when a match is found or an unmatched packet when no match is found,
perform a packet manipulation on the matched packet received at the third full duplex port or the fourth full duplex port according to the one or more corresponding packet manipulations in the third configuration table or the fourth configuration table to produce a second manipulated packet, and
forward the second manipulated packet or the unmatched packet to the third full duplex port or the fourth full duplex port.

4. The device of claim 1,
wherein the FPGA is further configured to operate in a sequential mode or a concurrent mode based on at least one of the first configuration table and the second configuration table,
wherein in the sequential mode, the FPGA increments to a next entry in at least one of the first configuration table and the second configuration table after performing a packet manipulation, and
wherein in the concurrent mode, the FPGA directly indexes into at least one of the first configuration table and the second configuration table based on the one or more packet match criteria.

5. The device of claim 1, further comprising:
a third full duplex port and a fourth full duplex port, each port configured to receive and transmit a plurality of Ethernet packets; and
a timestamp system configured to add a timestamp to a payload of one or more selected Ethernet packets of the plurality of Ethernet packets received at or transmitted out of the third full duplex port or the fourth full duplex port.

6. The device of claim 1, further comprising one or more timers and a timestamp system, wherein either the one or more timers or the timestamp system synchronizes time to the one or more Ethernet packets.

7. The device of claim 1, further comprising a plurality of Ethernet packets and a plurality of independent timers, wherein the FPGA is further configured to activate one or more of the plurality of independent timers to measure timing between each of the plurality of Ethernet packets based on at least one of the first configuration table and the second configuration table.

8. A method for processing an Ethernet packet, comprising:
receiving an Ethernet packet at a first full duplex port of a diagnostic device;
inspecting, at a media independent interface (MII) layer, a subset of bits of a MAC destination address of the Ethernet packet;
comparing the inspected subset of bits against one or more packet match criteria stored in at least one configuration table to determine whether the Ethernet packet is a matched packet when a match is found or an unmatched packet when no match is found;
if the Ethernet packet is a matched packet, performing a packet manipulation on the matched packet to produce a manipulated packet, wherein the packet manipulation is specified in the at least one configuration table; and
forwarding the manipulated packet or an unmatched packet to a second full duplex port of the diagnostic device.

9. The method of claim 8, wherein the packet manipulation includes at least one of: packet content modification with CRC update, packet termination, CRC corruption, or introducing a specified packet delay.

10. The method of claim 8, further comprising:
receiving a plurality of Ethernet packets at the first full duplex port; and
activating one or more independent timers to measure timing between each of the plurality of Ethernet packets received at the first full duplex port.

11. The method of claim 8, further comprising:
operating in a sequential mode or a concurrent mode based on the at least one configuration table,
wherein the sequential mode comprises incrementing to a next entry in the at least one configuration table after performing a packet manipulation, and
wherein the concurrent mode comprises directly indexing into the at least one configuration table based on the one or more packet match criteria.

12. The method of claim 8, further comprising:
a plurality of Ethernet packets;
a third full duplex port and a fourth full duplex port, each port configured to receive and transmit the plurality of Ethernet packets; and
adding a timestamp to a payload of one or more selected Ethernet packets of the plurality of Ethernet packets received at or transmitted out of the third full duplex port or the fourth full duplex port.

13. The method of claim 8,
receiving a plurality of Ethernet packets at the diagnostic device, the plurality of Ethernet packets comprising at least a first Ethernet packet and a second Ethernet packet;
receiving the first Ethernet packet at the first full duplex port and transmitting the first Ethernet packet out of the second full duplex port;
receiving the second Ethernet packet at a third full duplex port and transmitting the second Ethernet packet out of a fourth full duplex port;
entirely copying content of the first Ethernet packet to produce an entirely copied first Ethernet packet or selectively copying content of the first Ethernet packet to produce a selectively copied first Ethernet packet;
entirely copying content of the second Ethernet packet to produce an entirely copied second Ethernet packet or selectively copying content of the second Ethernet packet to produce a selectively copied second Ethernet packet;
receiving the entirely copied first Ethernet packet or selectively copied first Ethernet packet at a third full duplex port and transmitting the entirely copied first Ethernet packet or selectively copied first Ethernet packet out of a fourth full duplex port; and
receiving the entirely copied second Ethernet packet or selectively copied second Ethernet packet at the fourth full duplex port and transmitting the entirely copied second Ethernet packet or selectively copied second Ethernet packet out of the third full duplex port.

14. The method of claim 8, further comprising:
selectively dropping packets intermittently to simulate abnormal network conditions based on instructions in the at least one configuration table.

15. A non-transitory computer-readable medium storing configuration data that, when used to configure a programmable logic device (PLD), cause the PLD to perform operations for processing an Ethernet packet, the operations comprising:
receiving an Ethernet packet at a media independent interface layer (MII layer);
inspecting a subset of bits of a MAC destination address of the Ethernet packet, the subset of bits comprising 12 bits first listed in the subset of bits;
comparing the subset of bits that was inspected against one or more packet match criteria stored in at least one configuration table to determine whether the Ethernet packet is a matched packet if a match is found in the at least one configuration table or an unmatched packet if no match is found in the at least one configuration table;
if the Ethernet packet is a matched packet, performing a packet manipulation on the matched packet to produce a manipulated packet, wherein the packet manipulation is specified in the at least one configuration table; and
forwarding the manipulated packet or an unmatched packet with a delay of less than 6 microseconds.

16. The non-transitory computer-readable medium of claim 15, wherein the packet manipulation includes at least one of: packet content modification with CRC update, packet termination, CRC corruption, or introducing a specified packet delay.

17. The non-transitory computer-readable medium of claim 15, wherein the operations further comprise:
receiving a plurality of Ethernet packets at the MII layer; and
activating one or more independent timers to measure timing between each of the plurality of Ethernet packets based on instructions in the at least one configuration table.

18. The non-transitory computer-readable medium of claim 15, wherein the operations further comprise:
operating in a sequential mode or a concurrent mode based on the at least one configuration table,
wherein the sequential mode comprises incrementing to a next entry in the at least one configuration table after performing a packet manipulation, and
wherein the concurrent mode comprises directly indexing into the at least one configuration table based on the one or more packet match criteria.

19. The non-transitory computer-readable medium of claim 15, wherein the operations further comprise:
adding a timestamp to a payload of an Ethernet packet.

20. The non-transitory computer-readable medium of claim 15, wherein the operations further comprise:
receiving a plurality of Ethernet packets at a diagnostic device, the plurality of Ethernet packets comprising at least a first Ethernet packet and a second Ethernet packet;
receiving the first Ethernet packet at a first full duplex port and transmitting the first Ethernet packet out of a second full duplex port;
receiving the second Ethernet packet at the second full duplex port and transmitting the second Ethernet packet out of the first full duplex port;
entirely copying content of the first Ethernet packet to produce an entirely copied first Ethernet packet or selectively copying content of the first Ethernet packet to produce a selectively copied first Ethernet packet;
entirely copying content of the second Ethernet packet to produce an entirely copied second Ethernet packet or selectively copying content of the second Ethernet packet to produce a selectively copied second Ethernet packet;
receiving the entirely copied first Ethernet packet or selectively copied first Ethernet packet at a third full duplex port and transmitting the entirely copied first Ethernet packet or selectively copied first Ethernet packet out of a fourth full duplex port; and
receiving the entirely copied second Ethernet packet or selectively copied second Ethernet packet at the fourth full duplex port and transmitting the entirely copied second Ethernet packet or selectively copied second Ethernet packet out of the third full duplex port.
